(19) United States
(12) Patent Application Publication
(10) Pub. No.: US 2023/0186380 A1
(43) Pub. Date: Jun. 15, 2023

(54) BANK BALANCE FUNDS CHECK AND NEGATIVE BALANCE CONTROLS FOR ENTERPRISE RESOURCE PLANNING SYSTEMS

(71) Applicant: Jagadish Chandra Manohar, Toronto (CA)

(72) Inventor: Jagadish Chandra Manohar, Toronto (CA)

(21) Appl. No.: 18/164,794

(22) Filed: Feb. 6, 2023

Related U.S. Application Data
(63) Continuation-in-part of application No. 16/286,643, filed on Feb. 27, 2019, now abandoned.
Application No. 16/286,643 is a continuation of application No. 13/135,618, filed on Jul. 11, 2011, now abandoned.
Application No. 13/135,618 is a continuation-in-part of application No. 12/228,188, filed on Aug. 11, 2008, now abandoned.
(60) Provisional application No. 60/967,912, filed on Sep. 7, 2007.

(51) Int. Cl. G06Q 40/02; G06Q 10/06; G06Q 20/40; G06Q 40/12

(52) U.S. Cl. CPC G06Q 40/02; G06Q 10/06; G06Q 20/403; G06Q 20/4037; G06Q 40/12

(57) ABSTRACT

A system and a computer-implemented method to control transactions processed by an enterprise resource planning (ERP) system. A bank balance funds check controller checks existing bank balance funds available (BBFA), and validates transactions on detecting adequate BBFA, or prevents validation on detecting inadequate BBFA, thereby preventing negative funds resulting out of outgoing payment, by way of a restriction on a standard functionality of the BBFA fluctuating between positive and negative amounts. A negative balance controller accepts and processes incoming positive and negative receipts, and manages a situation arising there out of, irrespective of availability of adequate BBFA, resulting in negative bank funds or an increase in the existing negative bank funds available, by way of context-sensitive exceptions to the restriction. The controllers communicate with a standard functionality of the ERP system and with each other only via a central data store within a program server associated with the ERP system.

### CROSS-REFERENCE TO RELATED APPLICATIONS

This application is a continuation-in-part (CIP) patent application of the non-provisional patent application titled “Bank Balance Funds Check and Negative Balance Controls for Enterprise Resource Planning Systems”, application Ser. No. 16/286,643, filed in the United States Patent and Trademark Office (USPTO) on Feb. 27, 2019, which is a continuation application of the non-provisional patent application titled “Bank balance funds check and negative balance controls for enterprise resource planning systems”, application Ser. No. 13/135,618, filed in the USPTO on Jul. 11, 2011, which is a CIP patent application of the non-provisional patent application titled “Bank balance funds check and negative balance controls for enterprise resource planning systems”, application Ser. No. 12/228,188, filed in the USPTO on Aug. 11, 2008, which claims priority to and the benefit of the provisional patent application titled “Bank balance funds check and negative balance controls for ERP systems”, application No. 60/967,912, filed in the USPTO on Sep. 7, 2007. The specifications of the above referenced patent applications are incorporated herein by reference in their entirety.

### STATEMENT REGARDING FEDERALLY SPONSORED RESEARCH OR DEVELOPMENT

The subject of the disclosure given herein is not part of work done for the United States Government or any of its agencies. This is the applicant's original work that resulted during 2004-2007 when the applicant consulted the City of New York (NYC)'s human resources administration (HRA) on its Oracle financials reconfiguration project, through Adil Business Systems, Inc. (Adil). To the applicant's knowledge and understanding, the applicant might have signed non-disclosure-non-compete agreement with Adil but not signed any “work-made-for-hire” or equivalent agreement in favor of NYC, HRA, or Adil.

### BACKGROUND

Oracle® E-Business Suite is an enterprise resource planning (ERP) applications suite owned by Oracle Corporation headquartered in Austin, Tex., and organized into a number of product areas such as financials, manufacturing, project portfolio management, human resources, procurement, supply chain management, and customer relationship management, with each of these areas comprising individual application modules. The financials area of the ERP applications suite comprises the most used modules such as general ledger, payables, receivables, assets, and cash management. Every sub-ledger in an enterprise involving financial transactions posts information into the general ledger, where the general ledger is a sum total of all financial/accounting information. Adequate checks and controls are a must for any organization. While some controls reside in the general ledger, some reside in the appropriate sub-ledgers. In cases where the controls reside in the general ledger, their impact may well transcend across the sub-ledgers. The standard functionality of Oracle® Financials does not prevent writing checks when there are inadequate bank funds, in which case the books result in negative bank funds. Since checks cannot be issued with inadequate bank funds, the bank funds need to be manually checked each time a check is written to ensure that an associated transaction does not result in negative bank funds. The manual checking process is very cumbersome, labor-intensive, and risky, when multiple organization units, service areas, thousands of clients, bank accounts, large transaction volumes, and frequent funds constraints are involved. To preclude this, many organizations maintain large bank funds or have an overdraft facility, which involve various operating, financial, and procedural costs.

Negative bank funds are not possible in an ideal theoretical scenario, as a payment cannot be made, and a check should not be issued when there is no money in a bank account. However, during the course of normal day-to-day transactions, negative bank funds occur all the time. Negative bank funds may arise in the following two ways: by way of outgoing payment against an invoice, and by way of incoming negative receipt, in the form of a debit memo or a credit memo. All organizations may not have incoming negative receipts. While the incoming negative receipts are non-controllable as an organization generally cannot control the inflow of debit/credit memos, the outgoing payments are controllable as the organization can hold back the payments for any reason including inadequate bank funds. Accordingly, organizations need to have the ability to not proceed with issuing checks for payments when the available bank funds are inadequate, thus preventing negative bank funds resulting out of an outgoing invoice payment, and at the same time allowing negative bank funds as a result of incoming negative receipts. From a practical control perspective, one way to prevent the payment of an invoice is to perform a check before the transaction reaches the check writing stage. Conventional solutions do not provide organizations with the ability to withhold payments when the available bank funds are inadequate, preventing negative bank funds resulting from an outgoing invoice payment, and at the same time allowing negative bank funds as a result of an incoming negative receipt.

Hence, there is a long-felt, but unresolved/unaddressed need for a system and a computer-implemented method for controlling multiple enterprise transactions that impact bank funds by validating an enterprise transaction based on adequate bank funds for conducting the enterprise transaction. Moreover, there is a need for a system and a computer-implemented method for processing a negative receipt, irrespective of availability of adequate bank funds. Furthermore, there is a need for a system and a computer-implemented method for conducting financial transactions involving receipt processing, irrespective of whether the receipt processing results in negative bank funds or an increase in existing negative bank funds.

### SUMMARY OF THE INVENTION

This summary is provided to introduce a selection of concepts in a simplified form that are further disclosed in the detailed description of the invention. This summary is not intended to determine the scope of the claimed subject matter.

The computer system and the computer-implemented method disclosed herein address the above-recited need for controlling multiple enterprise transactions that impact bank funds by validating an enterprise transaction based on adequate bank funds for conducting the enterprise transaction. The computer system and the computer-implemented method disclosed herein also process a negative receipt, irrespective of availability of adequate bank funds. Furthermore, the computer system and the computer-implemented method disclosed herein conduct financial transactions involving receipt processing, irrespective of whether the receipt processing results in negative bank funds or an increase in existing negative bank funds. The computer system and the computer-implemented method disclosed herein provide controls for validating financial transactions performed through an enterprise resource planning (ERP) system. The computer system and the computer-implemented method disclosed herein control financial transactions by utilizing bank balance funds available (BBFA). The bank balance funds available can either be the balance available in a single bank account, or a combined balance available in one or more bank accounts. In an embodiment, one or more bank accounts are assigned for conducting the financial transactions using the bank balance funds available. The financial transactions comprise, for example, processing an invoice, an incoming positive receipt, an incoming negative receipt, a journal, etc.

The computer system and the computer-implemented method disclosed herein comprise automated controls, namely, a bank balance funds check controller also referred herein as a “bank balance funds check control”, and a negative balance controller also referred herein as a “negative balance control”. The bank balance funds check control and the negative balance control are developed in addition to the standard functionality of the enterprise resource planning system. The bank balance funds check control checks the bank balance funds available (BBFA) before each financial transaction and validates the financial transaction only if the BBFA is adequate. If the BBFA is inadequate, the bank balance funds check control prevents validation of the financial transaction. Since only validated financial transactions can be processed further, invoice type financial transactions that have not been validated do not reach a check writing stage, and as such, are not processed for payment.

The bank balance funds check control prevents negative bank funds resulting out of an enterprise financial transaction if the bank balance funds available (BBFA) is insufficient for conducting the enterprise financial transaction. As used herein, “negative bank funds” refer to negative bank balance funds available which is herein referred to as a “bank balance funds deficit”. The negative balance control allows conducting a financial transaction, even if the financial transaction results in a negative bank balance funds deficit (BBFD), or in an increase in the existing negative BBFD. The computer system and the computer-implemented method disclosed herein are automated and avoid manual intervention that is otherwise needed for conducting transactions in an enterprise resource planning system. The bank balance funds check control prevents a check being written against a financial transaction, for example, an invoice, when the BBFA is inadequate for processing the invoice. The negative balance control is used for allowing processing of a financial transaction irrespective of insufficient BBFA. For example, the negative balance control is specifically used for validating a financial transaction comprising processing of one or more of a negative receipt and a positive receipt, where the negative balance control validates the financial transaction even if the financial transaction results in a negative BBFD, or in an increase in the existing negative BBFD.

In an embodiment of the computer system and the computer-implemented method disclosed herein, the standard enterprise resource planning (ERP) system functionality, for example, the standard Oracle® Financials functionality, is built with the flexibility of bank balance funds available (BBFA) in one or more accounts fluctuating between positive and negative amounts. In another embodiment, the computer system and the computer-implemented method disclosed herein is implemented on all the ERP systems to restrict such flexibility. While the bank balance funds check control is developed as a restriction on the standard flexibility, the negative balance control is developed as context-sensitive exceptions to the restriction. While it is theoretically possible to have the bank balance funds check control implemented on a standalone basis, practical considerations show that both the bank balance funds check control and the negative balance control are needed in almost all cases. The negative balance control complements the bank balance funds check control, and the combined result is what is generally needed from an application user point of view. Implementing both the bank balance funds check control and the negative balance control is more complex than implementing one of the bank balance funds check control and the negative balance control for the ERP systems.

In an exemplary implementation, the computer system for controlling transactions processed by an enterprise resource planning (ERP) system comprises one or more of custom hardware, a hard-wired logic circuit, a combination of custom hardware and software, and a combination of a hard-wired logic circuit and software. The computer system further comprises a program server associated with the ERP system, at least one client device associated with the program server, multiple controllers integrated into the ERP system, and multiple additional accounting effect engines integrated into the ERP system and associated with the controllers. The program server comprises at least one processor, a memory unit operably and communicatively coupled to the processor(s), and at least one storage device configured to store a central data store therewithin. The central data store is configured for one or more of storage and management of one or more of programs, applications, data, and instructions. The storage and the management are central to a whole of the ERP system. Communication between component units of the ERP system is facilitated by a data bus. The client device(s) provides access to a user interface rendered by the program server. The user interface is accessible by a user through a display unit and one or more input devices associated with the program server. The client device(s) is configured to communicate with the program server through a network interface associated with the program server.

The controllers comprise the bank balance funds check controller and the negative balance controller as disclosed above. The bank balance funds check controller is configured to communicate with the standard functionality of the enterprise resource planning (ERP) system only via the central data store within the storage device(s) of the program server associated with the ERP system. The negative balance controller is configured to communicate with the standard functionality of the ERP system and the bank balance funds check controller only via the central data store within the storage device(s) of the program server associated with the ERP system. The central data store is configured such that each of the bank balance funds check controller, the negative balance controller, and the standard functionality of the ERP system is configured to natively query and update transaction details within the central data store. The updated transaction details are simultaneously available to the bank balance funds check controller, the negative balance controller, and the standard functionality of the ERP system. The computer system is so configured that it can meet the needs of new as well as existing ERP users alike. Furthermore, the above configuration improves the functioning of the ERP system by eliminating the need for direct interfacing between the bank balance funds check controller and the negative balance controller, and interfacing of each of the controllers with the standard functionality.

The computer system further comprises a control program comprising multiple computer program instructions stored in the storage device(s) and executable by the processor(s) of the program server. The computer program instructions when executed by the processor(s) cause the processor(s) to validate the transactions processed by the enterprise resource planning (ERP) system. The validation of the transactions results in allowing or preventing processing of the transactions by the standard functionality of the ERP system, thereby improving the functioning of the ERP system. In an embodiment, the validation of the transactions comprises detecting and handling exceptions that occur during the processing of the transactions by the standard functionality of the ERP system, when the standard functionality of the ERP system is unable to detect and handle the exceptions. The processing of the transactions comprises processing one of a journal, an invoice, a positive receipt, and a negative receipt. The detection and the handling of the exceptions is based on bank balance funds available and a transaction type. The exceptions comprise one or more of: (a) transactions that result in or increase negative bank balance funds available; and (b) being unable to process the positive receipt or the negative receipt due to an inadequacy of the bank balance funds available for processing the positive receipt or the negative receipt. The bank balance funds check controller is configured to determine the bank balance funds available by aggregating bank balance amounts available for the transactions in one or more related general purpose bank accounts. The bank balance funds check controller is further configured to allow the processing of the transactions based on determining an adequacy of the bank balance funds available for the processing of the transactions, thereby preventing negative bank balance funds from resulting in or increasing in the related general purpose bank account(s) as a result of the processing of the transactions. The negative balance controller is configured to monitor the transaction type and allow the processing of the positive receipt or the negative receipt, irrespective of the bank balance funds available being inadequate for the processing of the positive receipt or the negative receipt, thereby controlling and transforming the processing of the transactions by the computer system.

In an embodiment, the computer system controls and transforms the processing of the transactions as follows. The computer system creates a first additional account and a second additional account, each associated with the enterprise resource planning (ERP) system. The computer system attaches each of the first additional account and the second additional account with multiple transaction codes associated with the ERP system. In an embodiment, the computer system creates the first additional account by initializing a budget for the first additional account to zero; and defining a funds check level to absolute funds check level for the first additional account. The absolute funds check level is configured to check for funds available in the first additional account prior to the processing of the transactions. The transactions are processed only on the determination of the adequacy of the bank balance funds available for the processing of the transactions.

The computer system defines a first additional accounting effect, generated by one of the additional accounting effect engines associated with the bank balance funds check controller, for controlling the processing of the transactions. The computer system defines a second additional accounting effect, generated by another one of the additional accounting effect engines associated with the negative balance controller, for controlling the processing of the positive receipt and the negative receipt. The computer system references one of the transaction codes for controlling the processing of the transactions by the bank balance funds check controller, in communication with the standard functionality of the enterprise resource planning (ERP) system only via the central data store, based on the determination of the adequacy of the bank balance funds available for the processing of the transactions. The computer system allows the processing of the positive receipt or the negative receipt, by the negative balance controller, in communication with the standard functionality of the ERP system and the bank balance funds check controller only via the central data store, irrespective of the bank balance funds available being inadequate for the processing of the positive receipt or the negative receipt.

As part of controlling the processing of the transactions, the bank balance funds check controller, in communication with the standard functionality of the enterprise resource planning (ERP) system only via the central data store, is configured to prevent the processing of the transactions, on determining the inadequacy or a negative of the bank balance funds available for the processing of the transactions; and the negative balance controller, in communication with the standard functionality of the ERP system and the bank balance funds check controller only via the central data store, is configured to provide context-sensitive solutions to handle the exceptions occurring during the processing of the positive receipt or the negative receipt.

The bank balance funds available for the processing of the transactions is an aggregated balance available in the related general purpose bank account(s) for the processing of the transactions, excluding funds prior reserved for other purposes and therefore unavailable for the processing of the transactions. The related general purpose bank account(s) comprises one or more designated accounts for processing payment against the invoice. In an embodiment, the invoice is processed irrespective of availability of sufficient balance in the designated account(s) based on the determined adequacy of the bank balance funds available for the processing of the payment against the invoice. In an embodiment, the processing of the transactions comprises processing the transactions in one or more of an accounts payable sub-ledger, an accounts receivable sub-ledger, and a general ledger. The processed transactions are posted into the general ledger. In the event the controlling of the processing of the transactions leads to an increase or a decrease in the bank balance funds available, and the controlling of the processing of the transactions originates in any sub-ledger other than the accounts payable sub-ledger or the accounts receivable sub-ledger, the first additional accounting effect and the second additional accounting effect are implemented in the any sub-ledger in which the transaction originates in the same way as done in the accounts payable sub-ledger or the accounts receivable sub-ledger. In the event the controlling of the processing of the transactions leads to an increase or a decrease in the bank balance funds available, and none of an accounts payable sub-ledger window, an accounts receivable sub-ledger window, and any other originating sub-ledger window has a provision for the first additional accounting effect and the second additional accounting effect, then the first additional accounting effect and the second additional accounting effect are entered directly in the general ledger and processed concurrently with the processing of the transactions.

In an embodiment, the context-sensitive solutions provided by the negative balance controller comprise processing of the positive receipt or the negative receipt based on the bank balance funds available being positive; and processing of the positive receipt or the negative receipt based on the bank balance funds available being negative or zero. In an embodiment, the bank balance funds check controller, in communication with the standard functionality of the enterprise resource planning (ERP) system only via the central data store, is configured to reference a payment transaction code when a distribution account is an expense account and reference a receipt transaction code when the distribution account is a revenue account for controlling the processing of the invoice. In this embodiment, the first additional accounting effect comprises debiting the first additional account and crediting the second additional account by an amount of the invoice.

In an embodiment, the bank balance funds check controller, in communication with the standard functionality of the enterprise resource planning (ERP) system only via the central data store, is configured to reference a receipt transaction code for controlling the processing of the positive receipt. In this embodiment, the first additional accounting effect comprises crediting the first additional account and debiting the second additional account by an amount of the positive receipt. In another embodiment, the bank balance funds check controller, in communication with the standard functionality of the ERP system only via the central data store, is configured to reference a receipt transaction code for controlling the processing of the negative receipt. In this embodiment, the first additional accounting effect comprises debiting the first additional account and crediting the second additional account by an amount of the negative receipt.

In an embodiment, for controlling the processing of the negative receipt, the negative balance controller, in communication with the standard functionality of the enterprise resource planning (ERP) system and the bank balance funds check controller only via the central data store, is configured to execute the second additional accounting effect comprising crediting the first additional account and debiting the second additional account by an amount equal to a difference between an amount of the negative receipt and an amount of the bank balance funds available based on the bank balance funds available being positive and the amount of the negative receipt being greater than the amount of the bank balance funds available. In another embodiment, for controlling the processing of the negative receipt, the negative balance controller, in communication with the standard functionality of the ERP system and the bank balance funds check controller only via the central data store, is configured to execute the second additional accounting effect comprising crediting the first additional account and debiting the second additional account by an amount equal to an amount of the negative receipt based on the bank balance funds available being equal to zero or negative. In another embodiment, for controlling the processing of the positive receipt, the negative balance controller, in communication with the standard functionality of the ERP system and the bank balance funds check controller only via the central data store, is configured to execute the second additional accounting effect comprising debiting the first additional account and crediting the second additional account by an amount equal to a least of an amount of the positive receipt and an amount of a bank balance funds deficit. The bank balance funds deficit is negative bank balance funds available, on the bank balance funds available being equal to zero or negative.

In an embodiment, the bank balance funds check controller is implemented as a standalone control for the processing of the transactions. In another embodiment, the bank balance funds check controller and the negative balance controller are implemented for credit and prepaid situations, where a preauthorized limit is entered in addition to the first additional accounting effect and the second additional accounting effect. In this embodiment, the bank balance funds check controller and the negative balance controller are configured to allow a customer to use a credit service and/or a prepaid service up to a combined total of the bank balance funds available and the preauthorized limit. Transactions where the customer uses one of funds, the credit service, and the prepaid service beyond the combined total of the bank balance funds available and the preauthorized limit fail. Any interest or charges of a service provider is processed even when the transactions result in or increase usage in the bank balance funds available in the related general purpose bank account(s) over and beyond the bank balance funds available plus the preauthorized limit. In an embodiment, for controlling the processing of the positive receipt, the negative balance controller, in communication with the standard functionality of the enterprise resource planning (ERP) system and the bank balance funds check controller only via the central data store, does not generate the second additional accounting effect on determining that the bank balance funds available is positive. In another embodiment, for controlling the processing of the negative receipt, the negative balance controller, in communication with the standard functionality of the ERP system and the bank balance funds check controller only via the central data store, does not generate the second additional accounting effect on determining that the bank balance funds available is positive and an amount of the negative receipt is less than or equal to an amount of the bank balance funds available.

In an embodiment, the bank balance funds check controller, in communication with the standard functionality of the enterprise resource planning (ERP) system only via the central data store, is configured to debit or credit the first additional account, and correspondingly credit or debit the second additional account, by an amount equal to an amount of the transaction, and the negative balance controller, in communication with the standard functionality of the ERP system and the bank balance funds check controller only via the central data store, is configured to debit or credit the first additional account, and correspondingly credit or debit the second additional account, by an amount varying based on a combination of the bank balance funds available immediately prior to incoming transaction and details of the incoming transaction, ensuring the debited amount is equal to the credited amount in relation to each of the transactions. In an embodiment, the bank balance funds check controller, the negative balance controller, and the additional accounting effect engines, executed on the ERP system, are configured to meet requirements of a double entry system of bookkeeping same as the standard functionality of the ERP system.

Disclosed herein is also a computer-implemented method controlling transactions processed by an enterprise resource planning (ERP) system. In an embodiment, the computer-implemented method disclosed herein comprises providing a central data store in at least one storage device of a program server associated with the ERP system; integrating multiple controllers, namely, a bank balance funds check controller and a negative balance controller into the ERP system; integrating multiple additional accounting effect engines into the ERP system and associating the additional accounting effect engines with the controllers; and executing a control program comprising multiple computer program instructions stored in the storage device(s) and executable by the processor(s) of the program server for validating the transactions processed by the ERP system as disclosed above. The computer-implemented method disclosed herein further comprises executing the bank balance funds check controller to determine the bank balance funds available by aggregating the bank balance amounts available for the transactions in one or more related general purpose bank accounts; and allow the processing of the transactions based on determining an adequacy of the bank balance funds available for the processing of the transactions, thereby preventing negative bank balance funds from resulting in or increasing in the related general purpose bank account(s) as a result of the processing of the transactions. The computer-implemented method disclosed herein further comprises executing the negative balance controller to monitor the transaction type and allow the processing of the positive receipt or the negative receipt, irrespective of the bank balance funds available being inadequate for the processing of the positive receipt or the negative receipt, thereby controlling and transforming the processing of the transactions as disclosed above.

In one or more embodiments, related systems comprise circuitry and/or programming for executing the methods disclosed herein. The circuitry and/or programming comprise one or any combination of hardware, software, and/or firmware configured to execute the methods disclosed herein depending upon the design choices of a system designer. In an embodiment, various structural elements are employed depending on the design choices of the system designer.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific components, structures, and methods disclosed herein. The description of a component, or a structure, or a method step referenced by a numeral in a drawing is applicable to the description of that component, or structure, or method step shown by that same numeral in any subsequent drawing herein.

FIG. 1 exemplarily illustrates a comparative analysis of an implementation of a standard functionality of an enterprise resource planning (ERP) system alone and the standard functionality of the ERP system in combination with a bank balance funds check control and a negative balance control in an enterprise.

FIG. 2A exemplarily illustrates a tabular representation showing processing of transactions in a bank account.

FIG. 2B exemplarily illustrates a flow diagram showing effects of an implementation of the standard functionality of the ERP system, the bank balance funds check control, and the negative balance control.

FIG. 3 illustrates a schematic showing provision of additional accounting effects for invoices and receipts.

FIG. 4 exemplarily illustrates a block diagram of the bank balance funds check control and the negative balance control implemented within an ERP system.

FIGS. 5A-5C exemplarily illustrate a process flow diagram comprising steps of an embodiment of a method for controlling transactions processed by an ERP system.

FIG. 6A exemplarily illustrates a tabular representation showing an implementation of the bank balance funds check control and the negative balance control for invoices in different scenarios, where a distribution account is an expense account or a prepayment account.

FIG. 6B exemplarily illustrates a tabular representation showing an implementation of the bank balance funds check control and the negative balance control for invoices in different scenarios, where the distribution account is a revenue account.

FIG. 7A exemplarily illustrates a tabular representation showing an implementation of the bank balance funds check control and the negative balance control for receipts in scenarios 1.1, 1.21, and 1.22.

FIG. 7B exemplarily illustrates a tabular representation showing an implementation of the bank balance funds check control and the negative balance control for receipts in scenarios 2.1, 2.21, and 2.22.

FIG. 8 exemplarily illustrates a tabular representation of the results of implementation of the standard functionality of the ERP system, in comparison to the results of the implementation of the standard functionality of the ERP system in combination with the bank balance funds check control only and with the bank balance funds check control and the negative balance control.

FIG. 9 exemplarily illustrates a screenshot of a graphical user interface rendered by a program server associated with the ERP system for displaying referencing of a transaction code in a field of an accounts receivable (AR) receipts window during a transaction entry.

FIG. 10 exemplarily illustrates a screenshot of a graphical user interface rendered by the program server associated with the ERP system for displaying referencing of a transaction code in a field of an accounts payable (AP) invoices window.

FIG. 11 exemplarily illustrates a screenshot of a graphical user interface rendered by the program server associated with the ERP system for displaying referencing of a transaction code in a field of an AP invoice distributions window.

FIGS. 12-16 exemplarily illustrate screenshots of graphical user interface rendered by the program server associated with the ERP system for displaying journal entries for receipt scenarios 1.1, 1.21, 1.22, 2.1, and 2.2, respectively.

FIG. 17A exemplarily illustrates a block diagram of an enterprise resource planning system comprising a program server but without a bank balance funds check controller and a negative balance controller integrated into the enterprise resource planning system.

FIG. 17B exemplarily illustrates a block diagram of an enterprise resource planning system comprising a program server and a bank balance funds check controller and a negative balance controller integrated into the enterprise resource planning system for validating a financial transaction based on bank balance funds available in one or more bank accounts.

FIG. 18A illustrates an architectural block diagram of an exemplary implementation of a computer system configured as a program server for controlling transactions processed by an ERP system, wherein a control system comprising the bank balance funds check controller and the negative balance controller is implemented using one or more of a custom hardware, a hard-wired logic circuit, a combination of custom hardware and software, and a combination of a hard-wired logic circuit and software.

FIG. 18B illustrates an architectural block diagram of an exemplary implementation of a computer system configured as a program server for controlling transactions processed by an ERP system, wherein the control system comprising the bank balance funds check controller and the negative balance controller is implemented using software.

FIG. 19 exemplarily illustrates the implementation and results of the bank balance funds check control and the negative balance control in credit and prepaid situations.

FIG. 20A illustrates communication of the bank balance funds check controller with the standard functionality of the ERP system only via a central data store stored within at least one storage device of the program server associated with the ERP system.

FIG. 20B illustrates communication of the negative balance controller with the standard functionality of the ERP system and the bank balance funds check controller only via the central data store stored within at least one storage device of the program server associated with the ERP system.

FIG. 21 illustrates a flowchart of an embodiment of a computer-implemented method for controlling transactions processed by an ERP system.

FIG. 22 illustrates a distributed server system, comprising the program server, suitable for hosting the ERP system and implementing the control system.

### DETAILED DESCRIPTION OF THE INVENTION

Various aspects of the disclosure herein are embodied as a system, a method, or a non-transitory, computer-readable storage medium having one or more computer-readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”.

In an embodiment of the computer system and the computer-implemented method disclosed herein, a financial transaction should not be conducted if bank balance funds available (BBFA) is inadequate for conducting the financial transaction. As used herein, “bank balance funds available” refers to either a balance available in a single bank account or a combined uncommitted balance available in multiple applicable general purpose bank accounts for conducting enterprise financial transactions. The combined uncommitted balance represents funds that are not already reserved and are available for conducting any future transactions. The multiple applicable general purpose bank accounts comprise, for example, savings, checking 1, and checking 2 accounts. The financial transaction, for example, an invoice, should not be paid if the bank balance funds available in all applicable general purpose bank accounts is less than an invoice amount.

In another embodiment of the computer system and the computer-implemented method disclosed herein, a financial transaction, for example, an invoice payment, should be capable of being processed notwithstanding the availability of an adequate balance in a designated payment account, for example, a checking 2 account, provided adequate bank balance funds are available. Payment of the invoice amount notwithstanding the availability of adequate funds in the payment account avoids the need for transferring an amount sufficient to cover the payment of the invoice amount to the designated payment account from other accounts if the balance in the designated payment account is not adequate but there is an adequate bank balance funds available (BBFA). The above-disclosed embodiments of the computer system and the computer-implemented method disclosed herein are achieved by implementing a bank balance funds check controller also referred to as a “bank balance funds check control”. The bank balance funds check controller controls the financial transactions in the above-disclosed embodiments by implementing a restriction on a standard flexible functionality of an enterprise resource planning (ERP) system.

In another embodiment of the computer system and the computer-implemented method disclosed herein, a financial transaction, for example, processing incoming receipts, is conducted even if a negative receipt were to result in a negative bank balance funds deficit (BBFD), or an increase in the existing negative BBFD, by utilizing a negative balance controller also referred to as a “negative balance control”. Negative bank funds refer to negative bank balance funds available, herein referred to as a “bank balance funds deficit” (BBFD) or existing funds deficit. As used herein, “funds deficit” refers to total or net funds deficit on account of a combined bank balance and funds reserved. Also, as used herein, “combined bank balance” refers to a total of actual balances of all applicable general purpose bank accounts, for example, savings, checking 1, checking 2, etc. Also, as used herein, “funds reserved” refers to funds reserved on some transaction or transactions such as an invoice, pending full processing such as a payment, if any, irrespective of what intermediate stage the transaction is in, for example, encumbrance or liability. The negative balance controller allows a financial transaction to be conducted even if a negative receipt were to result in a negative BBFD or an increase in the existing negative BBFD by implementing context-sensitive exceptions to the restriction presented by the bank balance funds check controller.

The bank balance funds check controller is configured to communicate with a standard functionality of an enterprise resource planning (ERP) system only via a central data store within at least one storage device of a program server associated with the ERP system. The negative balance controller is configured to communicate with the standard functionality of the ERP system and with the bank balance funds check controller only via the central data store within the storage device(s) of the program server associated with the ERP system. The central data store is configured such that each of the bank balance funds check controller, the negative balance controller, and the standard functionality of the ERP system is configured to natively query and update transaction details within the central data store. The updated transaction details are simultaneously available to the bank balance funds check controller, the negative balance controller, and the standard functionality of the ERP system. The computer system is so configured that it can meet the needs of new and existing ERP users alike. Furthermore, the above configuration improves the functioning of the ERP system by eliminating the need for direct interfacing between the bank balance funds check controller and the negative balance controller and interfacing of each of the controllers with the standard functionality. More particularly the communication arrangement only via the central data store eliminates the need for the two controllers i.e., the bank balance funds check controller and the negative balance controller, to interface with the standard functionality or with each other via an application programming interface (API), separate manual data entry, or formatting and uploading of data files for data distribution from one component unit of the ERP system to another component unit, which are cumbersome, time-consuming, expensive, and also error prone. The communication arrangement of the computer system thus improves the functioning of ERP system by removing the need for these costly and risky manual methods, leading to faster, more efficient, error-free, and up-to-date information made available to all components of the ERP system simultaneously, which in turn increases productivity.

The bank balance funds check controller and the negative balance controller are implemented by combining a number of financial, accounting, and systems development principles, disparate standard application features, and custom programming, through a complex design, in a unique way, to achieve this unique, non-standard, high value, critical user need. The accounting principles comprise, for example, a double entry system of bookkeeping, journal entry, budgeting, budgetary controls, funds check, and encumbrance.

In an exemplary implementation, the computer system comprises one or more of custom hardware, a hard-wired logic circuit, a combination of custom hardware and software, and a combination of a hard-wired logic circuit and software. In an embodiment, the computer system and the computer-implemented method disclosed herein have been developed using automated additional accounting effects of financial transactions performed by a user, for example, invoice and receipt processing, in a way the computer system performs a user task as usual, and at the same time, creates an additional accounting effect or effects, as needed, depending on the details of the bank balance funds available and the transaction type of an incoming financial transaction.

“Oracle® General Ledger User Guide”, published by Oracle Corporation of Austin, Tex. “Oracle® General Ledger User’ Guide Release 11i, Part No. B12270-03, Chapter 7 Setup, When to Use Transaction Codes, Page 7-39 states “Use transaction codes whenever you need to create additional debit and credit pairs for a transaction”. “Oracle® General Ledger User’ Guide Release 11i, Part No. B12270-03, Chapter 7 Setup, When to Use Transaction Codes, Page 7-14 further states “You can use transaction codes to assist in budget execution or in any situation where you would like to customize the accounting effects of one transaction. When you reference a transaction code on a data entry window, General Ledger automatically generates the additional accounting entries predefined for that transaction code”. The computer system applies controls on custom-developed components of an additional accounting effect, which in turn, triggers an appropriate preventive control on the concerned financial transaction of the user in the case of an invoice before the financial transaction takes place, or allows the financial transaction as a context-sensitive exception to the restriction in the case of a receipt. The computer system exercises control at the invoice validation stage before the invoice can be selected for payment in a subsequent payment stage. Accordingly, an Additional Accounting Effect, as used herein can be defined as comprising additional debit and credit lines, following the double entry system of bookkeeping, created using one or more of transaction codes and context, to generate customized accounting effects of a user transaction, in which additional accounts are used to create transaction codes, and the amount of the additional accounting effect is same as or different from that of the user transaction, for the purpose of controlling the processing of the user transaction.

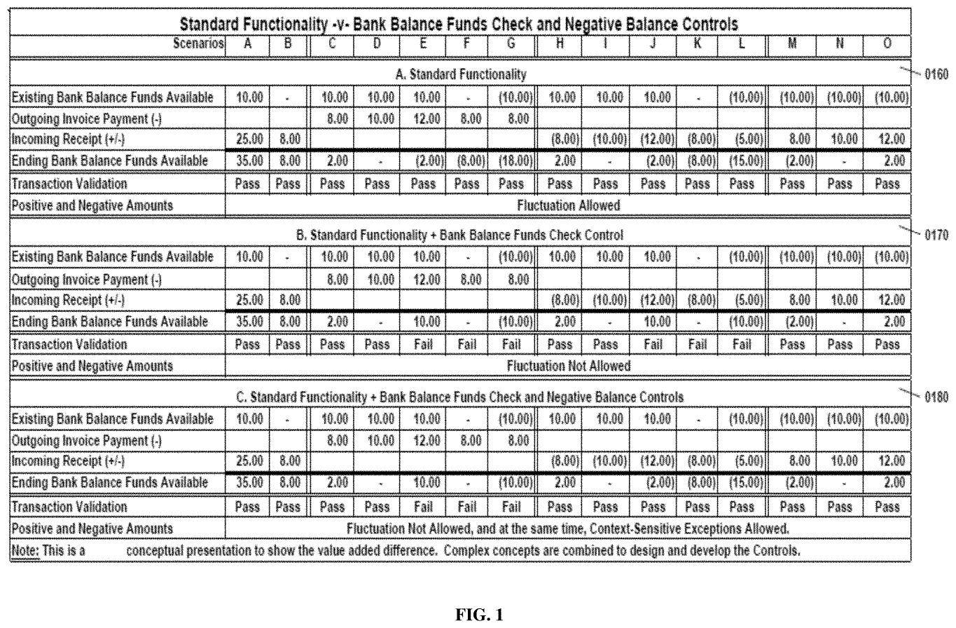

FIG. 1 exemplarily illustrates a comparative analysis of an implementation of a standard functionality 0160 of an enterprise resource planning (ERP) system alone, the standard functionality of the ERP system in combination with a bank balance funds check control 0170, and the standard functionality of the ERP system in combination with the bank balance funds check control and the negative balance control 0180 in an enterprise. In FIG. 1, numerals within parenthesis represent negative values and numerals without parenthesis represent positive values. The standard functionality 0160 validates a financial transaction irrespective of adequate bank balance funds available. The standard functionality and the bank balance funds check control combination 0170 validates the financial transaction if the bank balance funds available (BBFA) is sufficient for validating the financial transaction. The financial transaction is, for example, an outgoing invoice payment, an incoming positive receipt, an incoming negative receipt, a journal, etc. The incoming positive receipt is always validated because the incoming positive receipt increases the bank balance funds available. The standard functionality, the bank balance funds check control, and the negative balance control combination 0180 validates the outgoing invoice payment only if the bank funds available (BBFA) are adequate. The standard functionality, the bank balance funds check control, and the negative balance control combination 0180 validates the incoming negative receipt irrespective of adequate bank balance funds available for processing the incoming negative receipt.

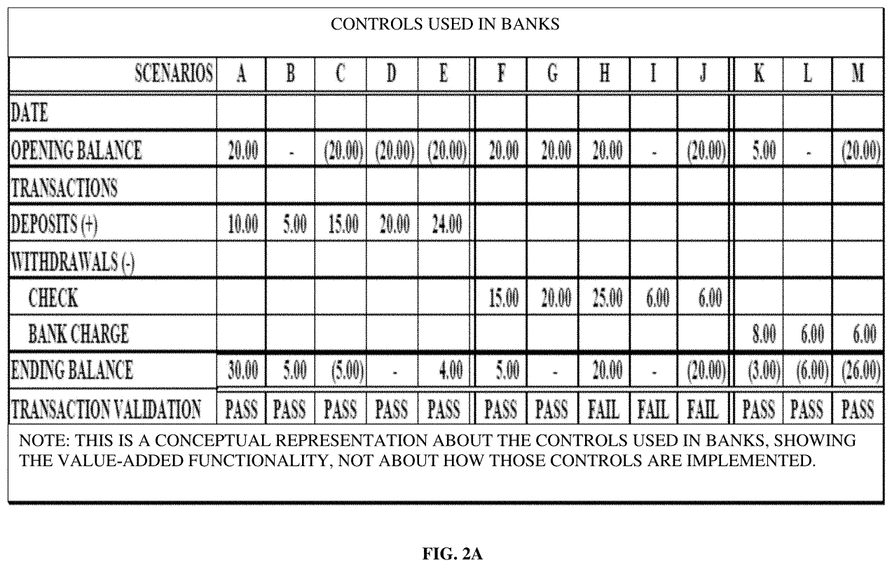

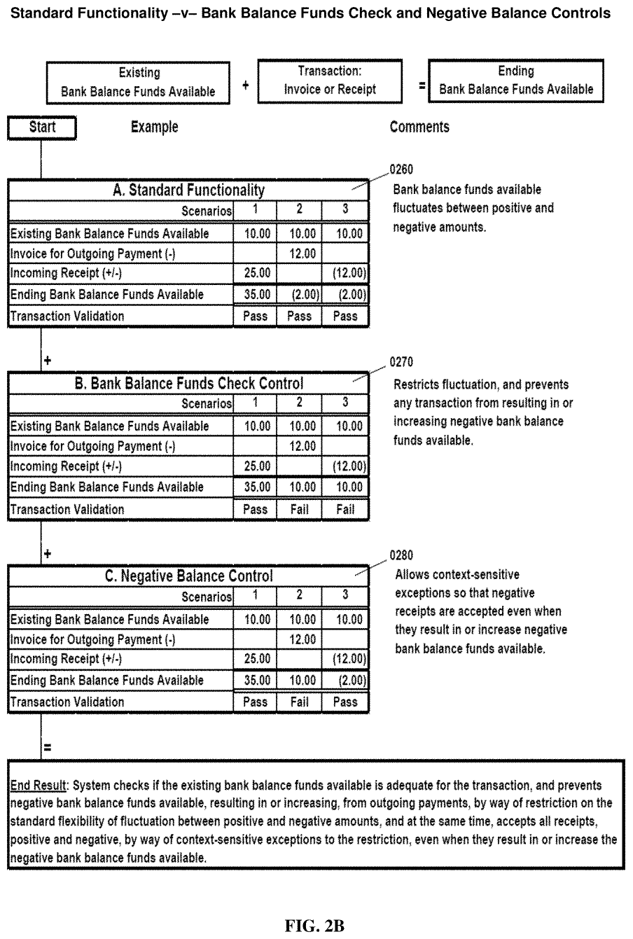

FIG. 2A exemplarily illustrates a tabular representation showing processing of transactions in a bank account including how a bank charge is processed in the absence of adequate balance in the bank account. The bank account, for example, is a checking 2 account. Conventionally, when the existing balance, that is, the opening balance in the bank account is less than a check amount, an automated system of the bank prevents the negative bank balance funds deficit (BBFD) in the bank account by preventing payment of the check. Columns F, G, H, I, and J of the table shown in FIG. 2A illustrate scenarios where an automated system of the bank rejects processing of the checks that result in negative BBFD, or in an increase in the negative bank balance funds in the bank account. In several other scenarios, when a transaction involves processing a bank charge, the transaction is performed regardless of the increase in the negative BBFD in the bank account. Columns K, L and M of the table shown in FIG. 2A illustrate scenarios where a bank charge is processed even if the bank charge results in or increases the existing negative BBFD in the bank account.

FIG. 2B exemplarily illustrates a flow diagram showing effects of an implementation of the standard functionality 0260 of the enterprise resource planning (ERP) system, the bank balance funds check control 0270, and the negative balance control 0280. As illustrated in FIG. 2B, the bank balance funds available fluctuate between a positive amount and a negative amount during implementation of the standard functionality 0260 alone as conventionally done. A combined implementation of the standard functionality and the bank balance funds check control 0270 restricts the fluctuation of the bank balance funds and prevents financial transactions that result in or increase the negative bank balance funds deficit (BBFD). A combined implementation of the standard functionality 0260, the bank balance funds check control 0270, and the negative balance control 0280 allows context sensitive exceptions for acceptance of the financial transactions resulting in an increase in the existing negative BBFD. The financial transactions for which the negative balance control 0280 allows context sensitive exceptions comprise processing negative and positive receipts.

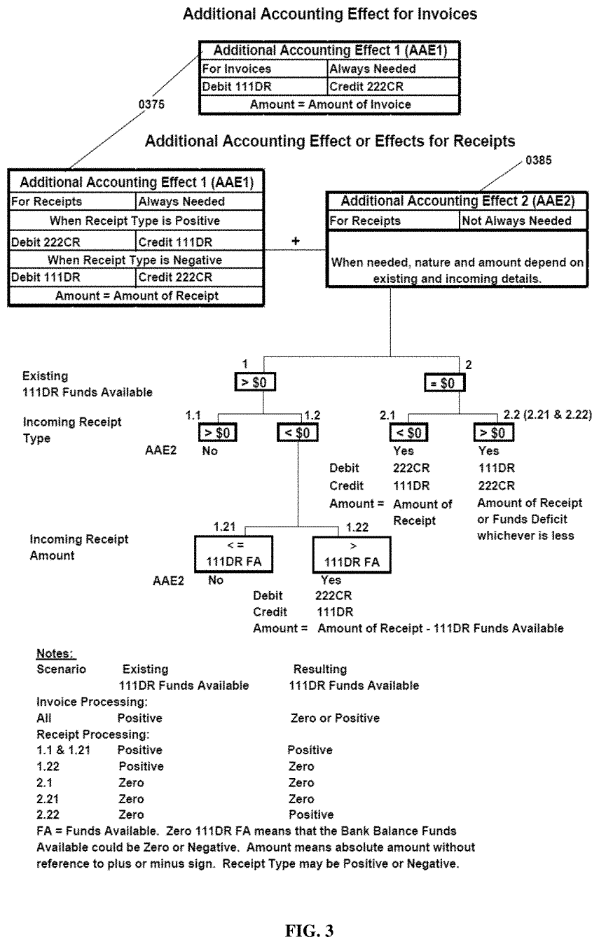

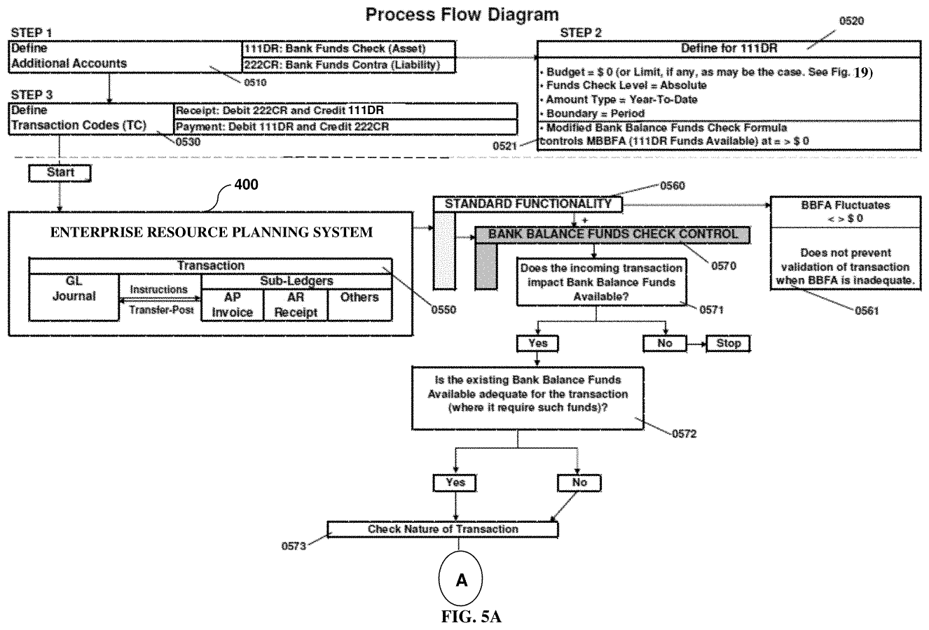

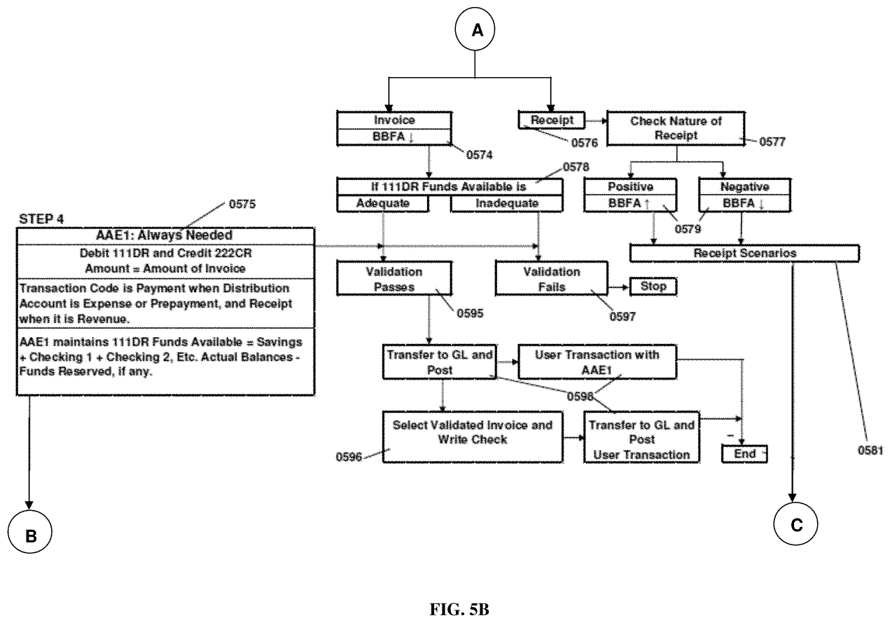

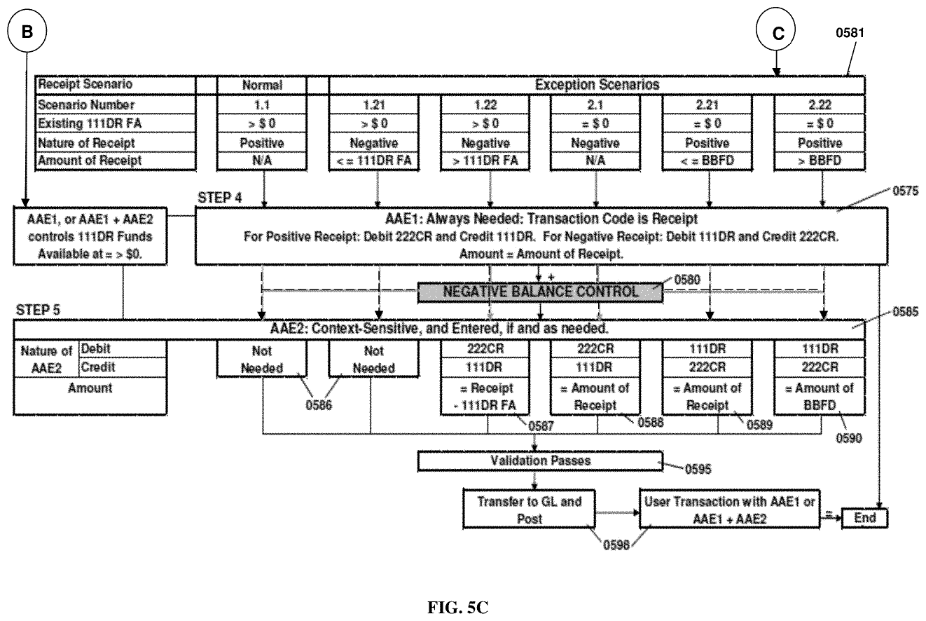

FIG. 3 illustrates a schematic showing provision of additional accounting effects for invoices and receipts. In an embodiment, the computer system and the computer-implemented method disclosed herein provide an additional accounting effect 1 (AAE1) 0375 and an additional accounting effect 2 (AAE2) 0385 for controlling processing of transactions as disclosed in the description of FIGS. 5A-5C. The AAE1 0375 prevents validation of an invoice when the bank funds available are inadequate. The AAE2 0385 allows processing of negative receipts even when the negative receipts result in a negative bank balance funds deficit (BBFD) or an increase in the existing negative BBFD.

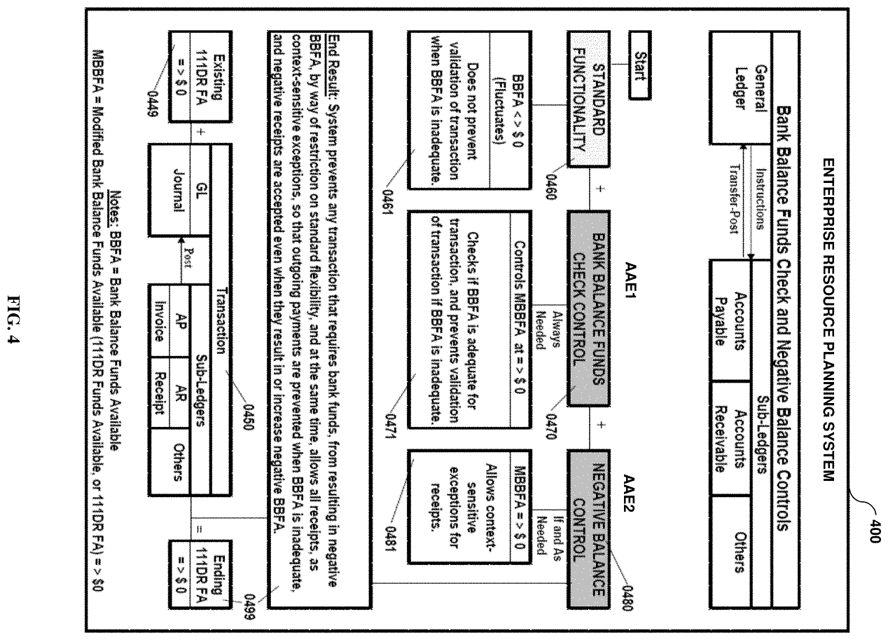

FIG. 4 exemplarily illustrates a block diagram of the bank balance funds check control 0470 and the negative balance control 0480 implemented within an enterprise resource planning (ERP) system 400. The computer system controls transactions processed by the ERP system 400 using the bank balance funds check control 0470 and the negative balance control 0480 as disclosed in the description of FIGS. 5A-5C. The transactions are processed in one or more of an accounts payable sub-ledger, an accounts receivable sub-ledger, and a general ledger as illustrated in FIG. 4.

FIGS. 5A-5C exemplarily illustrate a process flow diagram comprising steps of an embodiment of a method for controlling transactions processed by an enterprise resource planning (ERP) system 400 shown in FIG. 4. The computer system and the computer-implemented method disclosed herein provide automated controls referenced by the numerals 0470 and 0480 in FIG. 4 and referenced by the numerals 0570 and 0580 in FIG. 5A and FIG. 5C, respectively, for the ERP system 400. In an embodiment as exemplarily illustrated in FIG. 5A-5C, the computer-implemented method disclosed herein comprises five main steps as disclosed below.

Step 1: Defining and Creating Additional Accounts

In step 1, a pair of additional accounts, that is, non-user-used accounts, is created 0510. 5-digits are used to represent each account in this example. These additional accounts are:

a. a first additional account: 111DR bank funds check, defined as asset, debit balance normally; and
b. a second additional account: 222CR bank funds contra, defined as liability, credit balance normally.

The first additional account 111DR and the second additional accounts 222CR are created to meet the requirements of a double entry system of bookkeeping. The bank balance funds check control 0570 shown in FIG. 5A, and the negative balance control 0580 shown in FIG. 5C, are applied on the 111DR and 222CR additional accounts.

Step 2: Definitions for the 111DR Additional Account

A $0 budget amount is entered for the 111DR additional account for all periods. The following budgetary controls are defined 0520 for the 111DR additional account:

### Budget: Entered;

Bank funds check level: Absolute funds check level;
Amount type: Year-To-Date (YTD); and

### Boundary: Period.

For a particular account combination, the computer system presumes $0 budget when no budget amount is entered. The budgetary control absolute, for example the defined “absolute funds check level” implies that a financial transaction 0450 must always pass the funds check test. Else, the financial transaction 0450 fails. An amount type of year-to-date (YTD) and boundary of period is suitable when a yearly calendar is used with monthly periods.

The automated controls 0470, 0570 and 0480, 0580 provided by the computer system and the computer-implemented method disclosed herein validate a financial transaction based on the bank balance funds available in the bank accounts. The bank accounts are, for example, general purpose bank accounts comprising a checking 1 account, a checking 2 account, a savings account, etc. The automated controls 0470, 0570 and 0480, 0580 comprise:
a. The bank balance funds check control 0470 and 0570 shown in FIG. 4 and FIG. 5A, respectively; and
b. The negative balance control 0480 and 0580 shown in FIG. 4 and FIG. 5C, respectively.

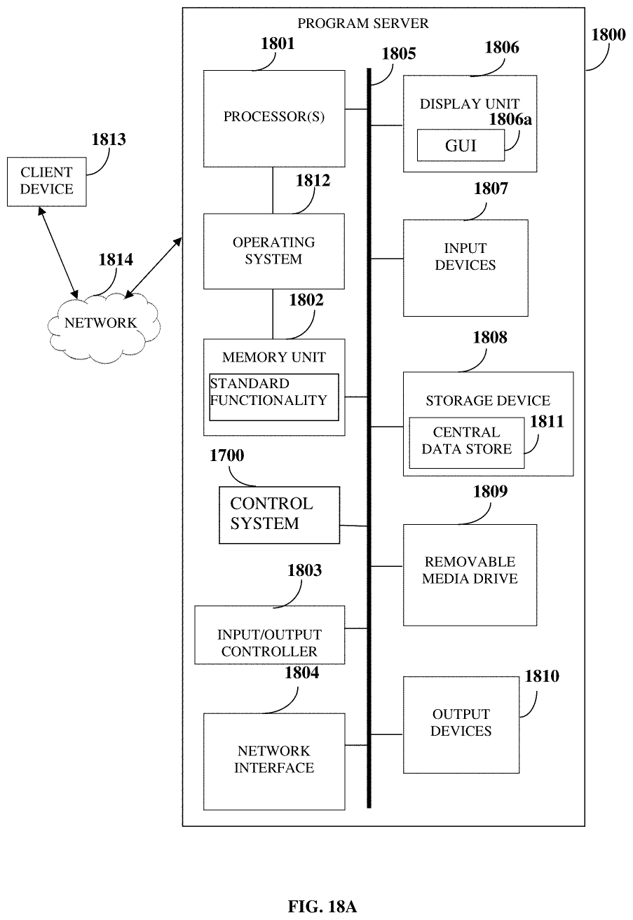

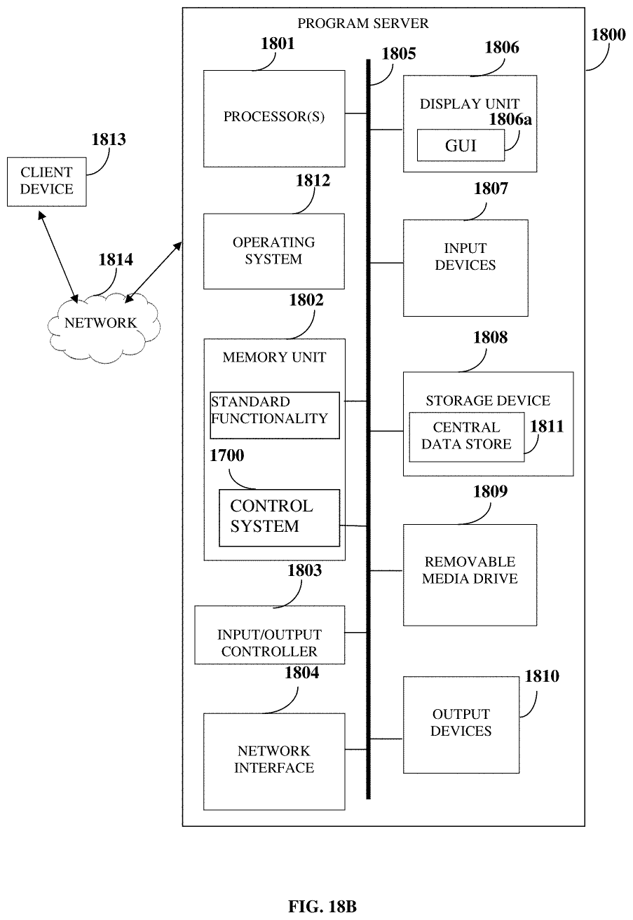

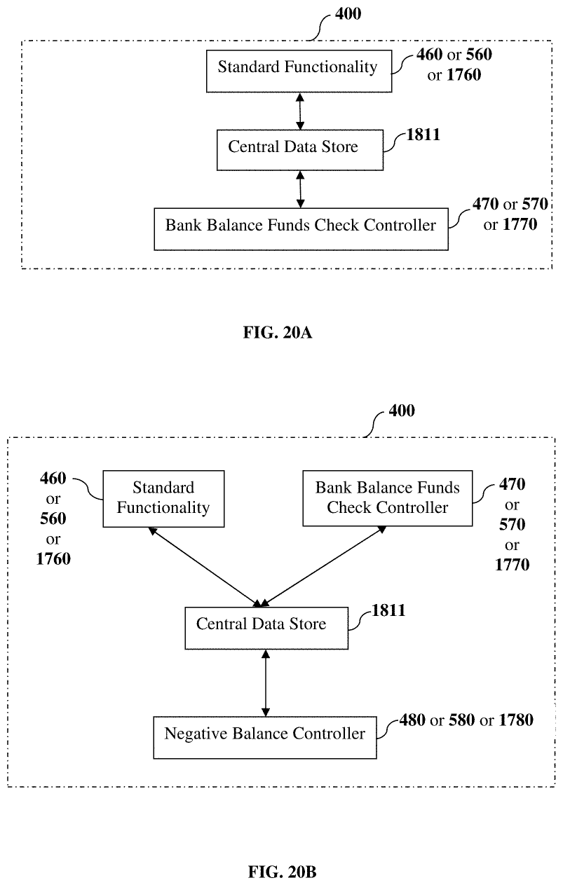

The bank balance funds check control 0470, 0570 is configured to communicate with a standard functionality 0460, 0560 of the enterprise resource planning (ERP) system 400 only via a central data store 1811 within at least one storage device 1808 of a program server associated with the ERP system 400 as illustrated in FIGS. 18A-18B and FIG. 20A. The negative balance control 0480, 0580 is configured to communicate with the standard functionality 0460, 0560 of the ERP system 400 and with the bank balance funds check control 0470, 0570 only via the central data store 1811 within the storage device(s) 1808 of the program server associated with the ERP system 400 as illustrated in FIGS. 18A-18B and FIG. 20B. The central data store 1811 is configured such that each of the bank balance funds check control 0470, 0570, the negative balance control 0480, 0580, and the standard functionality 0460, 0560 of the ERP system 400 is configured to natively query and update transaction details within the central data store 1811. The updated transaction details are simultaneously available to the bank balance funds check control 0470, 0570, the negative balance control 0480, 0580, and the standard functionality 0460, 0560 of the ERP system 400. The standard functionality of the ERP system 400, for example, the Oracle® standard functionality, referenced by the numerals 0460 and 0560 in FIG. 4 and FIG. 5A, respectively, uses the following exemplary formula for determining the funds available in an account:

Funds available in an account=budget−(actual+encumbrance).

In contrast, the bank balance funds check control 0470, 0570 and the negative balance control 0480, 0580 use a two-part modified bank balance funds check formula 0521 for the 111DR additional account, to maintain the 111DR funds available=>$0. As used herein, “111DR funds available” refers to an amount currently available up to which new commitments or reservations against funds can be made, for example, for an invoice payment. The subject controls, for example, 0470, 0570 and 0480, 0580 maintain this amount always equal to or greater than $0. An exemplary two-part modified bank balance funds check formula 0521 for the 111DR additional account, to maintain the 111DR funds available=>$0 is disclosed below:
a. When the difference between the combined actual balance available in the savings, checking 1, and checking 2 accounts and the combined funds reserved in the savings, checking 1, and checking 2 accounts is greater than zero, the bank balance funds available is equal to the difference between the actual balance and funds reserved. Disclosed below is a two-part modified bank balance funds check formula (111DR bank funds available) for the 111DR additional account when the difference is greater than zero:
   Savings+checking 1+checking 2 actual balances−funds reserved pending payment, if any, is >$0:
      Bank balance funds available (111DR bank funds available)=savings+checking 1+checking 2 actual balances−funds reserved, if any; and
b. When the difference between the combined actual balance available in the savings, checking 1, and checking 2 accounts and the combined funds reserved in the savings, checking 1, and checking 2 accounts is less than or equal to zero as shown below, the bank funds available is zero:
   Savings+checking 1+checking 2, etc., actual balances−funds reserved, pending payment, if any, is <=$0:
      Bank balance funds available (111DR bank funds available)=0.

Step 3: Defining Transaction Codes or Account Code Pairs

A pair of transaction codes, namely, “Receipt” and “Payment”, is created 0530 and additional accounts are attached to each of the transaction codes. An account code pair or a transaction code is used to create additional accounting effects. Transaction codes are standard features of most of the ERP systems. The additional accounts are attached to the transaction codes as follows:

a. Receipt: Debit 222CR and credit 111DR
b. Payment: Debit 111DR and credit 222CR

The bank balance funds check control 0470, 0570 and the negative balance control 0480, 0580 deal with financial transactions 0450, 0550 shown in FIG. 4 and FIG. 5A, that affect the bank balance funds available. Financial transactions 0450, 0550 involving receipts and invoices, that increase or decrease the bank balance funds available typically originate in accounts receivable (AR) and accounts payable (AP) of the ERP system 400. After being validated, the financial transactions 0450, 0550 are transferred to and posted in the general ledger (GL). The standard functionality 0460, 0560 of the ERP system 400 shown in FIG. 4 and FIG. 5A, is built with the flexibility of account balances and allows bank funds available to fluctuate between positive and negative amounts, and does not prevent writing a check when the bank funds available are inadequate 0461, 0561. As against this, the bank balance funds check control 0470, 0570 presents a restriction 0499 in case of all financial transactions 0450, 0550 that impact the bank balance funds available 0571. The bank balance funds check control 0470, 0570 presents the restriction by way of checking to see if the existing bank balance funds available (BBFA) are adequate 0572 for the financial transaction 0450, 0550 being conducted. Depending on the nature of the transaction 0573, the bank balance funds check control 0470, 0570 validates 0595 an invoice 0574 if adequate bank balance funds are available 0578, which is then selected for writing a check 0596. The bank balance funds check control 0470, 0570 prevents validation 0597 of the invoice when the bank balance funds available are inadequate 0471, by way of restriction on the standard flexible functionality of the ERP system 400.

The negative balance control 0480, 0580 is used for controlling processing of receipts 0576. The negative balance control 0480, 0580 validates 0499 all receipts 0577, even when the validated negative receipts result in a negative bank balance funds deficit (BBFD) or in an increase in an existing negative BBFD. The negative balance control 0480, 0580 validates the receipts, by way of context-sensitive exceptions to the restriction 0481 and 0581. The bank balance funds check control 0470, 0570 and the negative balance control 0480, 0580 validate a financial transaction 0450, 0550 if the financial transaction 0450, 0550 increases the bank balance funds available. For example, the bank balance funds check control 0470, 0570 and the negative balance control 0480, 0580 validate an incoming positive receipt since the positive receipt increases the bank balance funds available 0579.

Step 4: Additional Accounting Effect 1 (AAE1) 0575

Each time a transaction such as a general ledger (GL) journal, an accounts payable (AP) invoice, or an accounts receivable (AR) receipt having an impact on the bank balance funds available is processed, the appropriate transaction code, that is, receipt or payment, is automatically referenced in the financial transaction 0450, 0550 of the user, depending on the additional accounting effect required. Whenever a financial transaction 0450, 0550 increases the bank funds available, an equal credit to the 111DR additional account and debit to the 222CR additional account is entered. Example: Opening balances and receipts (positive amounts). Whenever a financial transaction 0450, 0550 decreases the bank balance funds available, an equal debit to the 111DR additional account and credit to the 222CR additional account are entered. Example: Invoices for outgoing payments, and receipts (negative amount).

From a user perspective, “bank balance funds available” means bank funds available to the extent not reserved on any other transaction, with reference to a particular organizational entity, for example, a client in the example used. In the Oracle® financials system, “funds available” means “budget−(actual+encumbrance)” with reference to a particular account combination.

The additional accounting effect 1 (AAE1) 0375, 0575 illustrated in FIG. 3 and FIG. 5B, is used to prevent validation of an invoice when the bank funds available are inadequate. The AAE1 0375, 0575 is referenced during every financial transaction. The amount of the AAE1 0375, 0575 is always equal to the amount of the client-specific user transaction 0450, 0550. Every user-specific financial transaction 0450, 0550 that increases or reduces the bank balance funds available references the appropriate transaction code as follows:
a. In the general ledger: During a journal entry: At the line level for the required lines.
   i. “Receipt” when the transaction increases the bank balance funds available.
   ii. ‘Payment’ when the transaction reduces the bank balance funds available.
b. In payables: During an invoice entry: At the header level for the entire invoice.
   i. “Payment” for invoices where all the distribution accounts of the invoice are expense accounts.
   ii. “Receipt” for all invoices where all the distribution accounts of the invoice are revenue accounts.
   iii. In the event some of the distribution lines are expense accounts and some are revenue accounts in the same invoice (very rare, or almost not there in reality), then in such cases, the appropriate transaction codes are referenced on each of the distribution lines on the distributions window, as needed, not in the invoice header. When the transaction code is referenced in the invoice header block, transaction code defaults to all the distribution lines in the distributions window, where transaction code can be changed, if and as needed.
c. In receivables: During a receipt entry: At the header level for the entire receipt. “Receipt” for all receipts, both positive and negative amount receipts.
d. Referencing the transaction code at the batch header is not advised whether for GL journal, the AP invoice, or the AR receipt.
e. The computer system automatically generates additional accounting effect 1 (AAE1) 0375, 0575 when an appropriate transaction code is referenced in the user transaction 0450, 0550 used in combination with AAE2 0385, 0585 illustrated in FIG. 3 and FIG. 5C, for processing of receipts.
f. None of the transaction codes should be referenced in financial transactions 0450, 0550 that do not increase or reduce the bank balance funds available. For example: Transfer from one bank account to another, for example, from a savings account to a checking 2 account.
g. In case of receipts, the “Receipt” transaction code is referenced. The computer system generates the AAE1 (credit or debit 111DR), as needed, depending on whether the incoming receipt is positive or negative 0577.

In an embodiment, the first and second additional accounts 111DR and 222CR, respectively, and the transaction codes “Receipt” and “Payment” follow a different nomenclature. In another embodiment, the nomenclature does not describe what the codes do.

Step 5: Additional Accounting Effect 2 (AAE2) 0585:

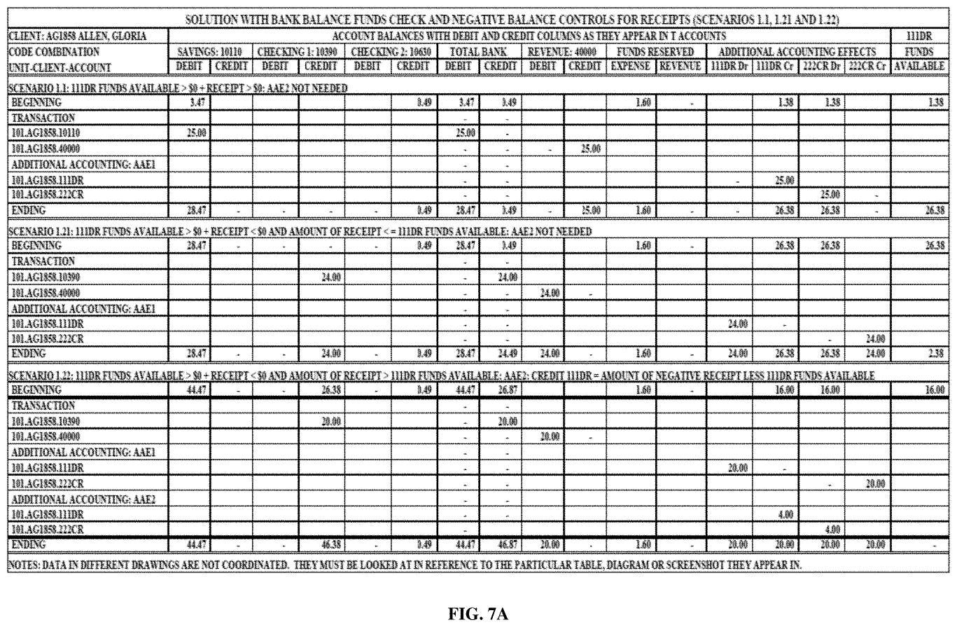

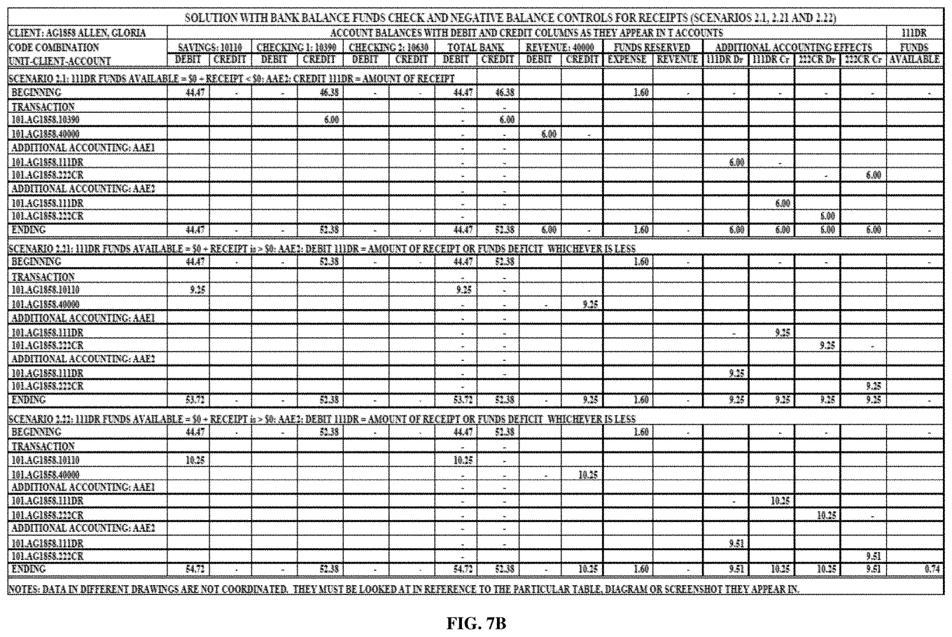

The additional accounting effect 2 (AAE2) 0385, 0585 illustrated in FIG. 3 and FIG. 5C, is used to allow processing of negative receipts even when the negative receipts result in a negative bank balance funds deficit (BBFD) or an increase in the existing negative BBFD. The AAE2 0385, 0585 is not always needed. When needed, the AAE2 0385, 0585 is used in addition to the AAE1 0375, 0575, to allow negative BBFD and manage the situation arising there out of, in conjunction with the ability to prevent validation of an invoice when the bank funds, that is, the combined uncommitted balance, are less than the invoice amount. Whether the AAE2 0385, 0585 is needed or not, exact nature and amount of the AAE2 0385, 0585 are context-based, and when needed, the amount is calculated depending on the existing and incoming criteria, as applicable, per scenarios 0581 discussed below:
a. Scenario 1.1: If the existing 111DR bank funds available (bank balance funds available) 0449 shown in FIG. 4, is positive (>$0) and the incoming receipt is positive (>$0): Additional accounting effect 2 0385, 0585: Not needed 0586.
b. Scenario 1.21: If the existing 111DR bank funds available (Bank balance funds available) 0449 is positive (>$0), the incoming receipt is negative (<$0) and the amount of the incoming negative receipt is <=Existing 111DR bank funds available: Additional accounting effect 2 (AAE2) 0385, 0585: Not needed 0586.
c. Scenario 1.22: If the existing 111DR bank funds available (bank balance funds available) 0449 is positive (>$0), the incoming receipt is negative (<$0), and the amount of the incoming negative receipt is >existing 111DR bank funds available (Bank balance funds available): Additional accounting effect 2 (AAE2) 0385, 0585: Debit 222CR and credit 111DR, equal in amount, to the amount of incoming negative receipt less existing 111DR bank funds available 0587.
d. Scenario 2.1: If the existing 111DR bank funds available (bank balance funds available) 0449 is =$0 and the incoming receipt is negative (<$0): Additional accounting effect 2 (AAE2) 0385, 0585: Debit 222CR and credit 111DR, equal in amount, to the amount of the incoming negative receipt 0588.
e. Scenario 2.2: If the existing 111DR funds available (bank balance funds available) 0449 is =$0 and the incoming receipt is positive (>$0): Additional accounting effect 2 (AAE2) 0385, 0585: Debit 111DR and credit 222CR, equal in amount, to the amount of the incoming receipt or existing funds deficit, whichever is less 0589 and 0590. The existing funds deficit is the negative bank balance funds available, herein referred to a bank balance funds deficit (BBFD).
f. For the purpose of better understanding, FIG. 7B illustrates scenario 2.2 with two sub-scenarios 2.21 and 2.22.

Financial transactions 0450, 0550 leading to increase or decrease in the bank balance funds available, originating in any sub ledger other than payables and receivables need the additional accounting effects as disclosed herein. Payables and receivables windows of the mother application include a provision to reference transaction code and enter the additional accounting effect 2. The additional accounting effect 1 and the additional accounting effect 2 are directly entered in the general ledger for the originating sub-ledger of the ERP system 400 devoid of provision to reference the transaction code and enter the additional accounting effect 2. The additional accounting effects are validated 0595 along with the financial transaction 0450, 0550. The validated financial transactions are transferred to and posted in the general ledger 0598.

When transaction entry is done manually into the ERP system 400, one of the predefined transaction codes may be automated or manually selected in the appropriate ledger windows. All other features of the computer system would be predefined and automated. When transaction entry is automated such as transactions coming into the ERP system 400 from feeder systems or otherwise, all features of the computer system would be predefined and automated. Manual intervention, as may be needed in the case of non-standard situations for implementing the computer implemented method and system disclosed herein is on the same lines as disclosed for implementing the automated controls.

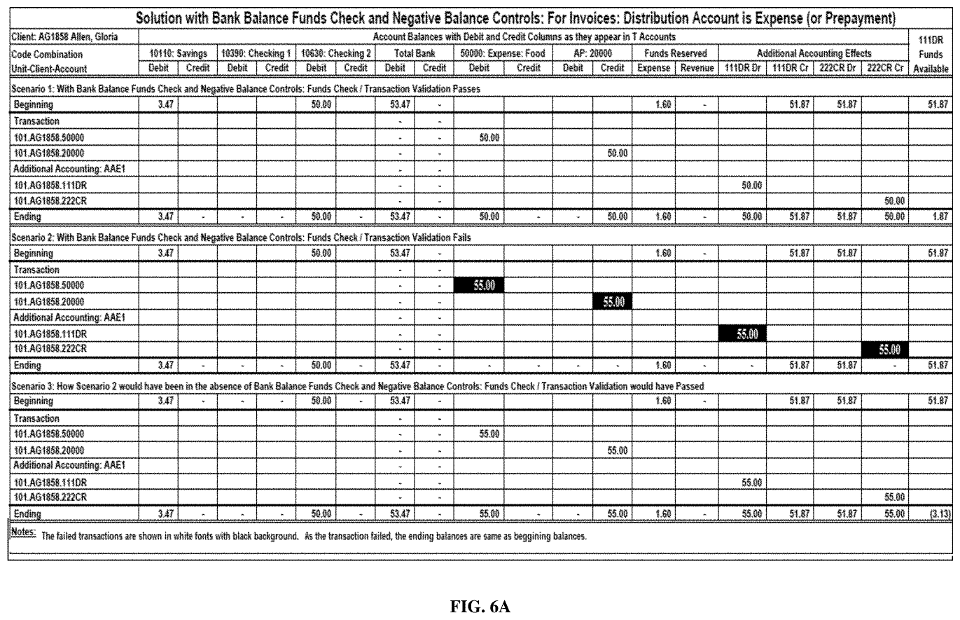

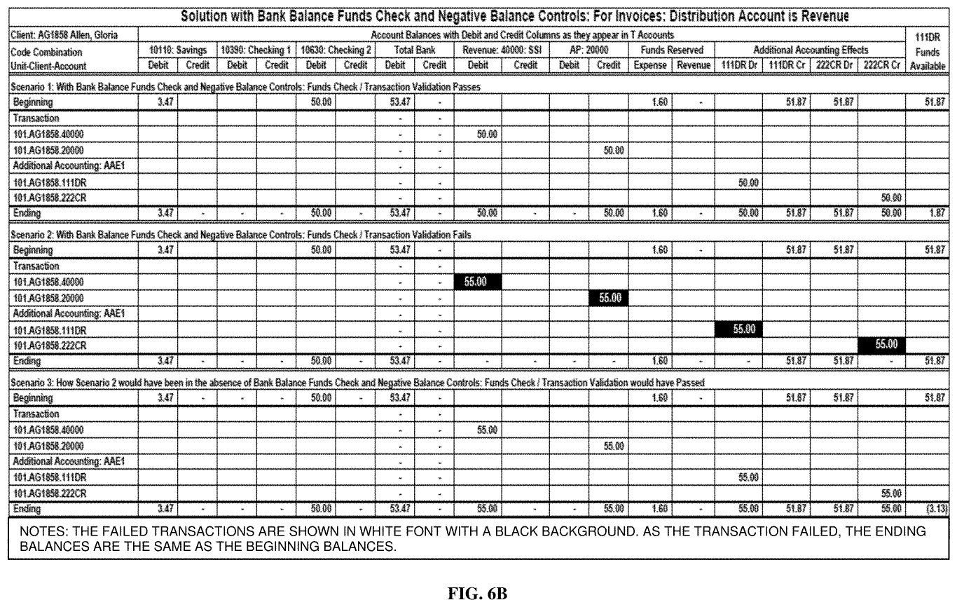

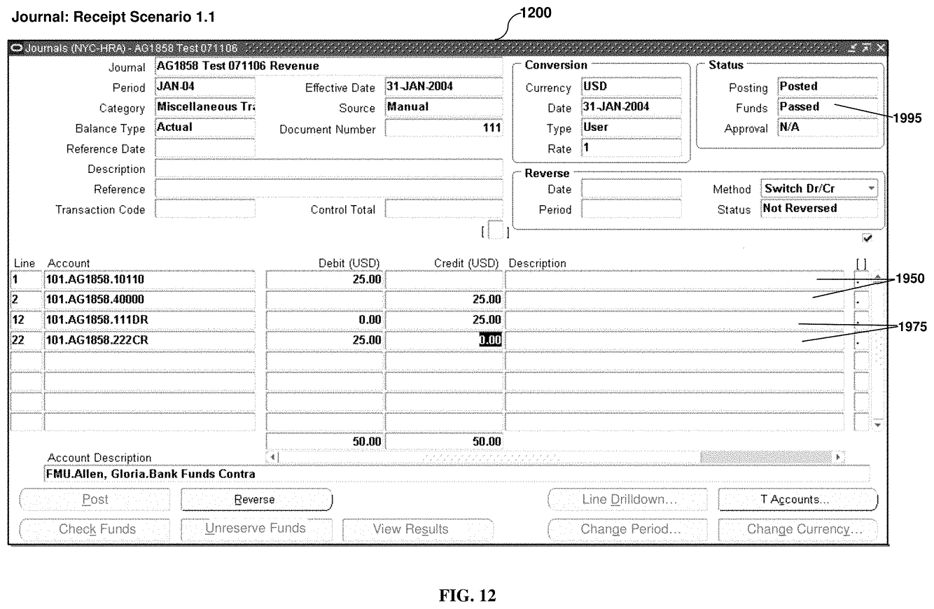

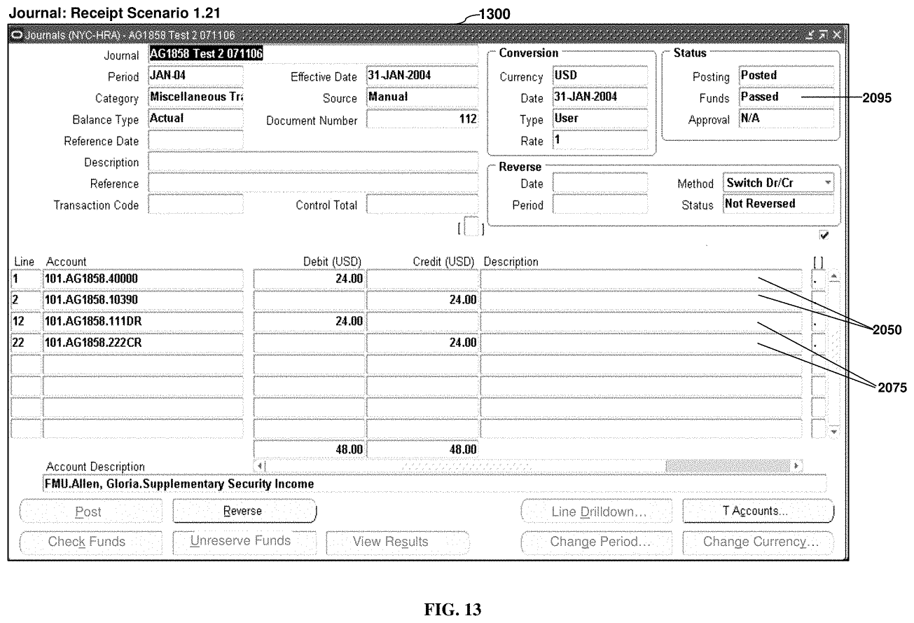

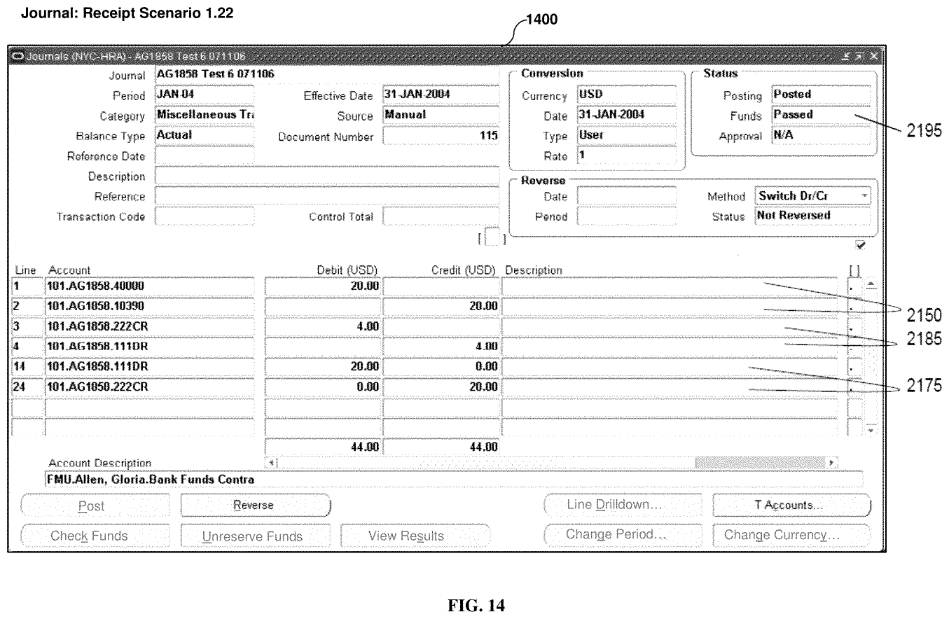

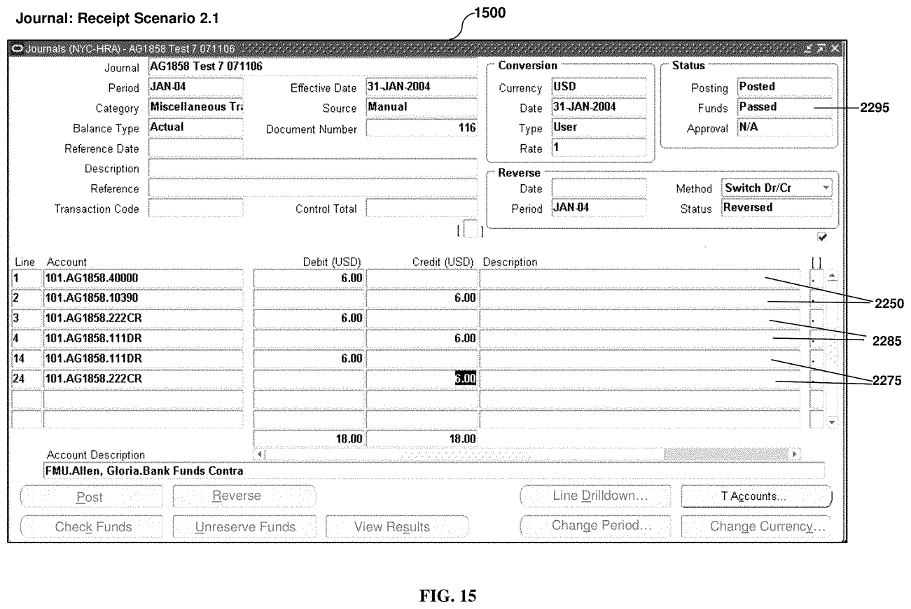

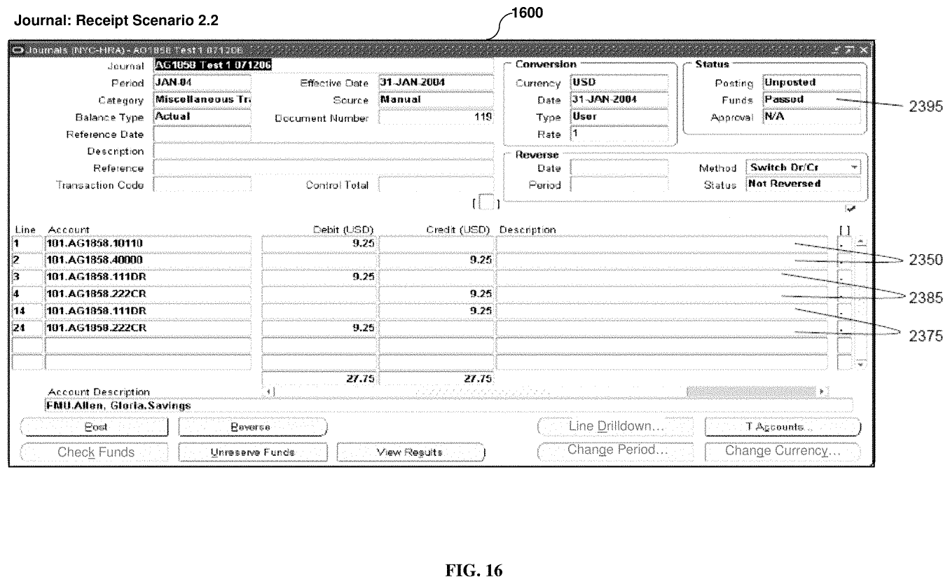

FIG. 6A and FIG. 6B exemplarily illustrate solutions in relation to invoice processing. FIG. 6A illustrates a tabular representation showing an implementation of the bank balance funds check control 0470, 0570 and the negative balance control 0480, 0580 shown in FIG. 4, FIGS. 5A, and FIG. 5C, for invoices in different scenarios, where a distribution account is an expense account or a prepayment account. FIG. 6B exemplarily illustrates a tabular representation showing an implementation of the bank balance funds check control 0470, 0570 and the negative balance control 0480, 0580 for invoices in different scenarios, where the distribution account is a revenue account. FIG. 7A and FIG. 7B exemplarily illustrate solutions with the bank balance funds check control 0470, 0570 and the negative balance control 0480, 0580 in relation to receipt processing. FIG. 7A exemplarily illustrates a tabular representation showing an implementation of the bank balance funds check control 0470, 0570 and the negative balance control 0480, 0580 shown in FIG. 4, FIGS. 5A, and FIG. 5C, for receipts in scenarios 1.1, 1.21 and 1.22 illustrated in FIG. 12, FIG. 13, and FIG. 14, respectively. FIG. 7B exemplarily illustrates a tabular representation showing an implementation of the bank balance funds check control 0470, 0570 and the negative balance control 0480, 0580 for receipts in scenario 2.1 illustrated in FIG. 15 and receipt in scenarios 2.21 and 2.22 denoted as scenario 2.2 illustrated in FIG. 16.

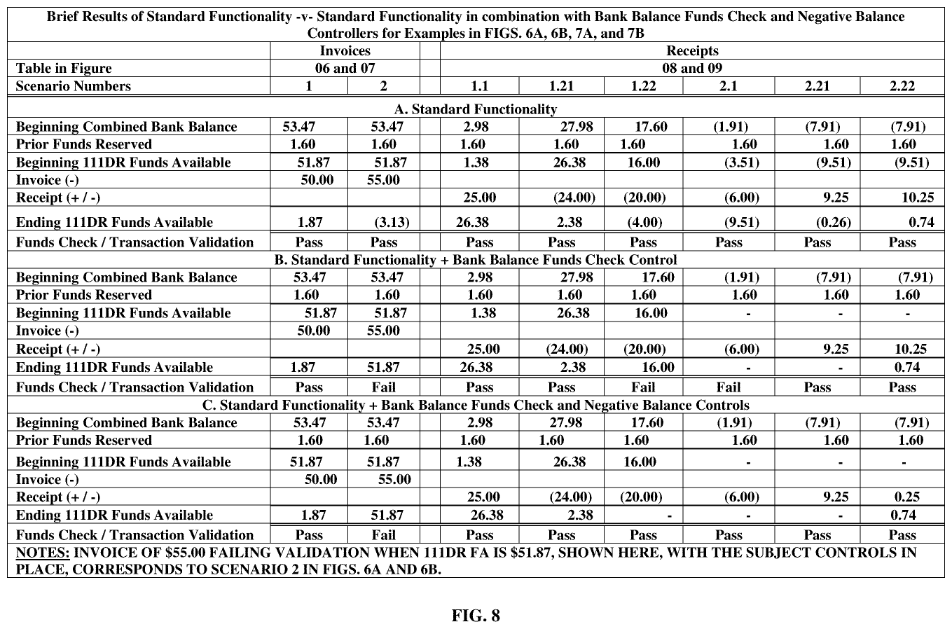

FIG. 8 exemplarily illustrates a tabular representation of the results of implementation of the standard functionality 0460, 0560 of the enterprise resource planning (ERP) system 400 shown in FIG. 4 and FIG. 5A, in comparison to the results of the implementation of the standard functionality 0460, 0560 of the ERP system 400 in combination with the bank balance funds check control 0470, 0570 only and with the bank balance funds check control 0470, 0570 and the negative balance control 0480, 0580 shown in FIG. 4, FIG. 5A, and FIG. 5C. The results shown in FIG. 8 are applicable to the example scenarios shown in FIGS. 6A-6B, and FIGS. 7A-7B. As a result of the controls, that is the bank balance funds check control 0470, 0570 and the negative balance control 0480, 0580, the 111DR funds available, that is, the bank balance funds available in the first additional account 111DR, is always kept equal to the actual combined bank balance minus the funds reserved, if any, when the combined bank balance minus the funds reserved is positive, and to $0 when the combined bank balance minus the funds reserved, if any, is zero or negative. The controls, for example, 0470, 0570 and 0480, 0580 are implemented such that when fully automated, the controls 0470, 0570 and 0480, 0580 operate the same way irrespective of whether it is a new or existing ERP user and whether the transaction entry is done directly into the ERP system manually, or the transactions come into the ERP system from feeder systems through interface, or otherwise automated, and automatically trigger one or more of the additional accounting effects AAE1 0375, 0575 and AAE2 0385, 0585 illustrated in FIG. 3 and FIGS. 5B-5C, for the general ledger (GL) journal, the accounts payable (AP) invoice, and the accounts receivable (AR) receipt entries. The combined practical result of the bank balance funds check control 0470, 0570 and the negative balance control 0480, 0580 operating together is that the computer system prevents negative bank balance funds deficit (BBFD) resulting or increasing out of invoice payment, and at the same time, allows negative receipt even if the payment were to result in or increase the negative bank BBFD.

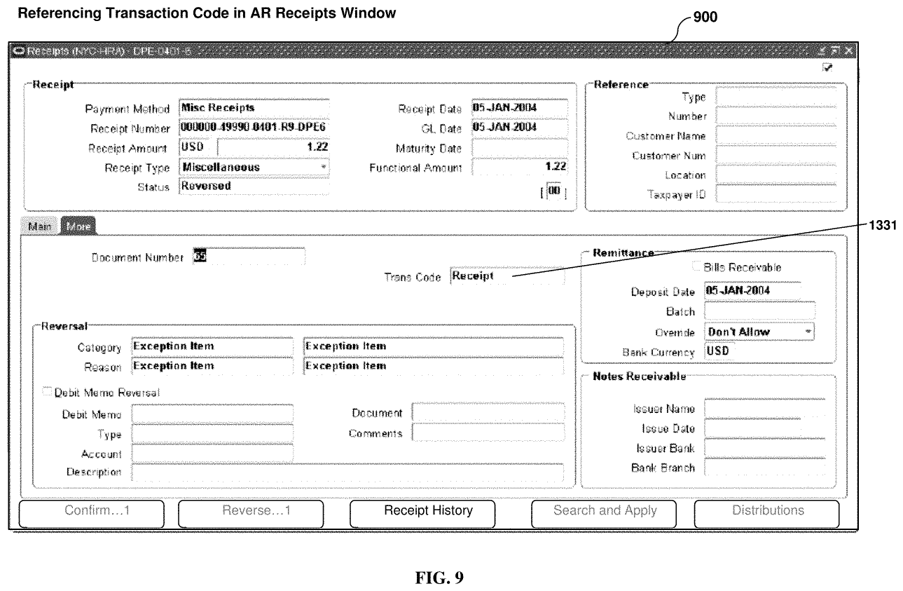

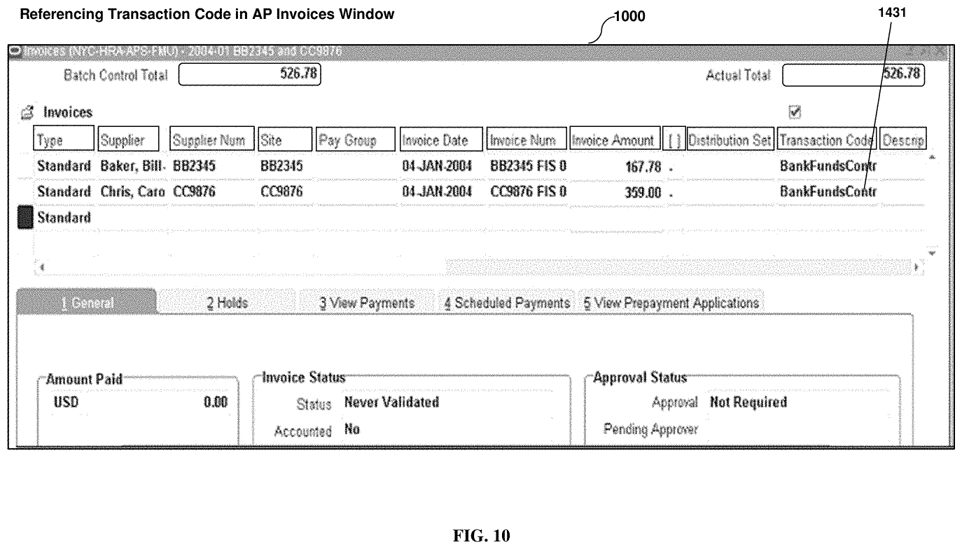

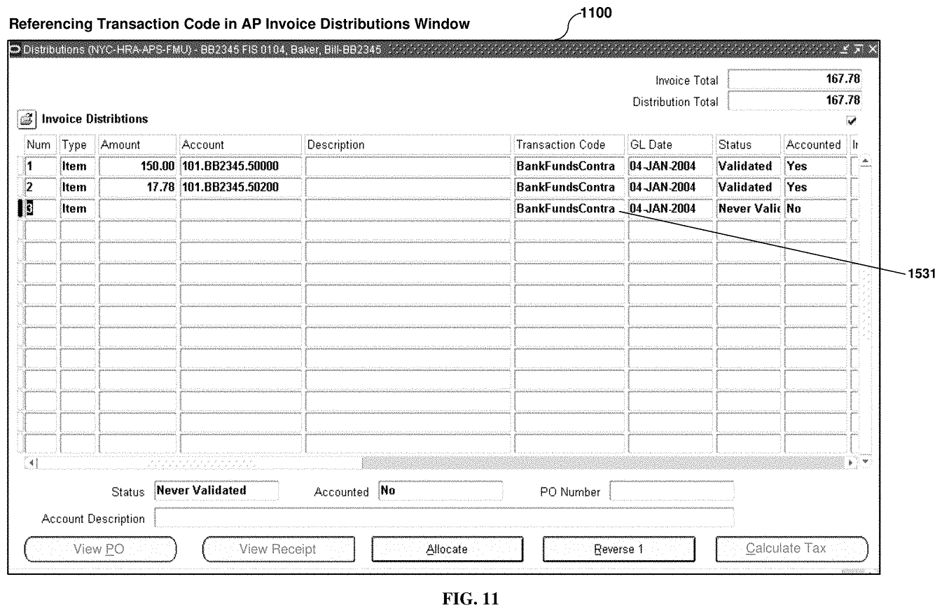

Screenshots, captured from applicant's Human Resources Administration (HRA) implementation, show with better visual effect, how the controls, that is, the bank balance funds check control 0470, 0570 and the negative balance control 0480, 0580 as designed and implemented, work. FIG. 9 exemplarily illustrates a screenshot of a graphical user interface (GUI) 900 rendered by a program server associated with an enterprise resource planning (ERP) system for displaying referencing of an appropriate transaction code in a field 1331 of an accounts receivable (AR) receipts window during transaction entry. FIG. 10 exemplarily illustrates a screenshot of a GUI 1000 rendered by the program server associated with the ERP system for displaying referencing of an appropriate transaction code in a field 1431 of an accounts payable (AP) invoices window during invoice entry. FIG. 11 exemplarily illustrates a screenshot of a GUI 1100 rendered by the program server associated with the ERP system for displaying referencing of a transaction code in a field 1531 of an AP invoice distributions window. The fields 1331, 1431, and 1531 illustrated in FIG. 9, FIG. 10, and FIG. 11, respectively, allow changing of the transaction code as needed.

FIGS. 12-16 exemplarily illustrate screenshots of graphical user interfaces (GUIs) 1200, 1300, 1400, 1500, and 1600 rendered by the program server associated with an enterprise resource planning (ERP) system for displaying journal entries generated by the automated controls, for example, 0470, 0570 and 0480, 0580 shown in FIG. 4, FIG. 5A, and FIG. 5C, for the receipt scenarios 1.1, 1.21, 1.22, 2.1, and 2.2 (2.21 and 2.22), respectively. The GUIs 1200, 1300, 1400, 1500, and 1600 display the type of journal entry generated by the computer system, as appropriate, for each of the receipt scenarios, with lines 1950, 2050, 2150, 2250, and 2350 in the journal entry representing a user's financial transactions for receipt scenarios 1.1, 1.21, 1.22, 2.1, and 2.2 respectively, as well as lines representing the additional accounting effect 1 0375 and lines representing the additional accounting effect 2 0385 shown in FIG. 3. It is to be noted that while the receipt scenarios 1.1 and 1.21 have only additional accounting effect 1, receipt scenarios 1.22, 2.1, and 2.2 (2.21 and 2.22) have both additional accounting effects 1 and 2. “Funds” fields 1995, 2095, 2195, 2295, and 2395 in “status” blocks of the GUIs 1200, 1300, 1400, 1500, and 1600, respectively, display “passed” or equivalent when the transaction passes the funds check, and “failed” or equivalent when the transaction fails the funds check. The “status” blocks of the GUIs 1200, 1300, 1400, 1500, and 1600 also display the state of posting or not posting of the journal. The GUIs 1200, 1300, 1400, 1500, and 1600 display details of the exact nature and amount of the additional accounting effect (AAE) or effects, the journal lines corresponding to an invoice or receipt transaction, and lines corresponding to the related AAE1, or AAE1 and AAE2. FIGS. 12-13 illustrate AAE1 journal lines 1975 and 2075 as appropriately needed for the receipt scenarios 1.1 and 1.21, respectively. FIGS. 14-16 illustrate AAE1 journal lines 2175, 2275, and 2375 and AAE2 journal lines 2185, 2285, and 2385, respectively, as appropriately needed for the receipt scenarios 1.22, 2.1, and 2.2 therein shown as 2150, 2250, and 2350, respectively. Invoice and prepayment scenarios comprise only AAE1. Normal receipt scenario 1.1 and exception receipt scenario 1.21 also have only AAE1. Exception receipt scenarios 1.22, 2.1, and 2.2 have both AAE1 and AAE2.

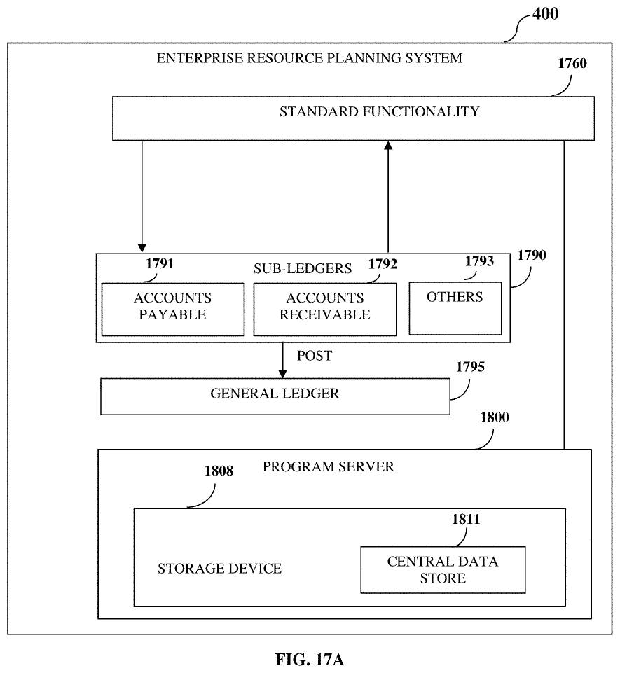

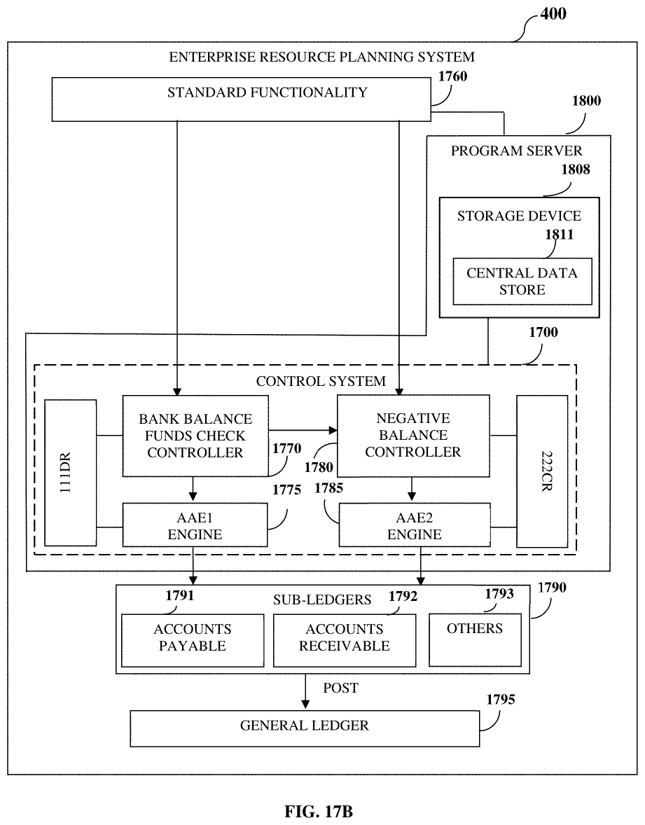

FIG. 17A exemplarily illustrates a block diagram of an enterprise resource planning (ERP) system 400 comprising a program server 1800 but without a bank balance funds check controller 1770 and a negative balance controller 1780 integrated into the ERP system 400.

FIG. 17B exemplarily illustrates a block diagram of an enterprise resource planning (ERP) system 400 comprising a program server 1800 and a bank balance funds check (BBFC) controller 1770 and a negative balance controller 1780 integrated into the ERP system 400 for validating a financial transaction based on bank balance funds available (BBFA) in one or more bank accounts. The ERP system 400 comprises the ERP standard functionality 1760, the integrated controllers, namely, the BBFC controller 1770 and the negative balance controller 1780, and additional accounting effect (AAE) engines, namely, an AAE1 engine 1775 and an AAE2 engine 1785. The BBFC controller 1770 determines the bank balance funds available in one or more bank accounts, on request for conducting a financial transaction. The financial transaction comprises, for example, processing one of a journal, an invoice, a positive receipt, and a negative receipt. The BBFC controller 1770 validates the financial transaction if the bank balance funds available are adequate for conducting the financial transaction. The BBFC controller 1770 prevents validation of the financial transaction if the bank balance funds available are inadequate for conducting the financial transaction. The negative balance controller 1780 validates the financial transaction irrespective of the bank balance funds available being inadequate for processing a receipt, if the financial transaction comprises processing a positive receipt or a negative receipt. The AAE1 engine 1775 generates an additional accounting effect 1 (AAE1) when an appropriate transaction code is referenced in a user transaction, used in combination with AAE2 for processing of receipts. The AAE2 engine 1785 generates an additional accounting effect 2 (AAE2) which is used to allow processing of receipts and manage the situation arising there out of even when the receipts result in negative bank balance funds deficit (BBFD) or increase the existing negative BBFD. The AAE1 engine 1775 and the AAE2 engine 1785 operably communicate with sub-ledgers 1790 of the ERP system 400. The sub-ledgers 1790 comprise an accounts payable sub-ledger 1791, an accounts receivable sub-ledger 1792, and other sub-ledgers 1793. In an embodiment, the computer system processes transactions in one or more of an accounts payable sub-ledger 1791, an accounts receivable sub-ledger 1792, and a general ledger 1795. The processed transactions are posted into the general ledger 1795. In an embodiment, the integrated controllers, namely, the BBFC controller 1770 and the negative balance controller 1780, and additional accounting effect (AAE) engines, namely, the AAE1 engine 1775 and the AAE2 engine 1785 are part of a control system 1700, as shown in FIG. 17B. In an embodiment, the control system 1700 is implemented within the program server 1800. In an embodiment, as shown in FIG. 18A, the control system 1700 comprises one or more of a custom hardware, a hard-wired logic circuit, a combination of custom hardware and software, and a combination of a hard-wired logic circuit and software to implement the plurality of integrated controllers, namely, the BBFC controller 1770 and the negative balance controller 1780, and additional accounting effect (AAE) engines, namely, the AAE1 engine 1775 and the AAE2 engine 1785. In another embodiment, as shown in FIG. 18B, the control system 1700 comprises software to implement the plurality of integrated controllers.

In an embodiment, the program server 1800 houses the computer system of the ERP system 400 along with the standard functionality 1760, sub ledgers 1790, general ledger 1795, and the storage device 1808.

FIG. 18A illustrates an architectural block diagram of an exemplary implementation of a computer system configured as a program server 1800 for controlling transactions processed by an ERP system 400 shown in FIG. 4, FIG. 5A, and FIG. 17B, wherein the control system 1700 comprising the bank balance funds check controller 1770 and the negative balance controller 1780 is implemented using one or more of a custom hardware, a hard-wired logic circuit, a combination of custom hardware and software, and a combination of a hard-wired logic circuit and software.

FIG. 18B illustrates an architectural block diagram of an exemplary implementation of a computer system configured as a program server 1800 for controlling transactions processed by an enterprise resource planning (ERP) system 400 shown in FIG. 4, FIG. 5A, and FIG. 17B, wherein the control system 1700 comprising the bank balance funds check controller 1770 and the negative balance controller 1780 is implemented using software.

The program server 1800 is programmable using high-level computer programming languages. In an embodiment, the program server 1800 is a server system employed for the ERP system 400, comprising one or more servers located at one or more geographical locations, together referred to herein as “program server,” “program servers” or “program server system,” for validating a financial transaction based on bank balance funds available in one or more bank accounts. In another embodiment, the program server 1800 is configured as a server cluster that is maintained at a fixed location. An ERP system package comprising the standard functionality 1760 and the controls, namely, the bank balance funds check (BBFC) controller 1770 and the negative balance controller 1780 illustrated in FIG. 17B, is installed on the program server 1800. The BBFC controller 1770 and the negative balance controller 1780 are integrated into the ERP system 400. Additional accounting effect (AAE) engines 1775 and 1785 illustrated in FIG. 17B, are also integrated into the ERP system 400 and associated with the controllers 1770 and 1780. The ERP package, the controllers 1770 and 1780, and the additional accounting effect engines 1775 and 1785 are deployed and implemented in the program server 1800 using programmed and purposeful hardware. In an embodiment, the controllers 1770 and 1780 and the additional accounting effect engines 1775 and 1785 are computer-embeddable systems that control transactions processed by the ERP system 400. The ERP system package, the controllers 1770 and 1780, and the additional accounting effect engines 1775 and 1785, when loaded into the program server 1800, transform the program server 1800 into a specially-programmed, special purpose computing device configured to implement the transaction control functionality disclosed herein. The program server 1800 is accessible to users through a broad spectrum of technologies and client devices, for example, 1813. The program server 1800 is communicatively coupled to the client device(s) 1813 via a network 1814. The client device(s) 1813 is an electronic device, for example, a personal computer with access to the internet, a tablet computing device, a mobile computer, a mobile phone, an internet-enabled cellular phone, a smartphone, a portable computing device, a laptop, a personal digital assistant, a wearable computing device such as smart glasses, a smart watch, etc., a touch-centric device, a workstation, a portable electronic device, a network-enabled computing device, an interactive network-enabled communication device, a device capable of running a web browser, any other suitable computing equipment, combinations of multiple pieces of computing equipment, etc.

In another embodiment, the program server 1800 is implemented in a cloud computing environment. As used herein, “cloud computing environment” refers to a processing environment comprising configurable, computing, physical, and logical resources, for example, networks, servers, storage media, virtual machines, applications, services, etc., and data distributed over the network 1814. The cloud computing environment provides an on-demand network access to a shared pool of the configurable, computing, physical, and logical resources. In an embodiment, the program server 1800 is a cloud-based platform implemented as a service for controlling transactions processed by the ERP system 400. For example, the program server 1800 is configured as a software as a service (SaaS) platform or a cloud-based software as a service (CSaaS) platform that controls transactions processed by the ERP system 400. In another embodiment, the program server 1800 is implemented locally as an on-premise platform comprising on-premise software installed and run on client systems on the premises of an organization, for example, an enterprise, a retail store, a bank, etc., to meet privacy and security requirements.

The network 1814 that connects the client device(s) 1813 to the program server 1800 is a short-range network or a long-range network. For example, the network 1814 is one of: the internet, satellite internet, an intranet, a wired network, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. The program server 1800 interfaces with the client device(s) 1813, and in an embodiment, with one or more database systems (not shown) and servers (not shown) to control transactions processed by the ERP system 400, and therefore more than one specifically programmed computing system is used for implementing the transaction control service disclosed herein.

In an embodiment as exemplarily illustrated in FIG. 18, the program server comprises at least one processor 1801, a memory unit 1802 operably and communicatively coupled to the processor(s) 1801, at least one storage device 1808, and a central data store 1811 stored within the storage device(s) 1808. The processor(s) 1801 is an electronic circuit that executes computer programs. The processor(s) 1801 is configured to execute computer program instructions stored in the memory unit 1802 and the storage device(s) 1808 for controlling transactions processed by the ERP system 400. The processor(s) 1801 refers to one or more microprocessors, central processing unit (CPU) devices, finite state machines, computers, microcontrollers, digital signal processors, logic, logic devices, application-specific integrated circuits (ASICs), field-programmable gate arrays (FPGAs), chips, etc., or any combination thereof, capable of executing computer programs or a series of commands, instructions, or state transitions. In an embodiment, the processor(s) 1801 is implemented as a processor set comprising, for example, a programmed microprocessor and a math or graphics co-processor. The program server 1800 is not limited to employing the processor(s) 1801. In an embodiment, the program server 1800 employs a controller or a microcontroller. The memory unit 1802 is a non-transitory, computer-readable storage medium configured to store computer program instructions executable by the processor(s) 1801. The memory unit 1802 is a storage unit used for recording, storing, and reproducing data, program instructions, and applications. In an embodiment, the memory unit 1802 comprises a random-access memory (RAM) or another type of dynamic storage device that serves as a read and write internal memory and provides short-term or temporary storage for information and instructions executable by the processor(s) 1801. In another embodiment, the memory unit 1802 further comprises a read-only memory (ROM) or another type of static storage device that stores firmware, static information, and instructions for execution by the processor(s) 1801. In an embodiment, the modules of the ERP system 400 are stored in the memory unit 1802.

The storage device(s) 1808 is a fixed media drive of the program server 1800. The central data store 1811 stored within the storage device(s) 1808 is configured for storage and/or management of one or more of programs, applications, data, and instructions. The storage and the management are central to a whole of the ERP system 400. The central data store 1811 also stores information and instructions for execution by the processor(s) 1801. The central data store 1811 also stores temporary variables, static information, and other intermediate information used during execution of the instructions by the processor(s) 1801. The bank balance funds check (BBFC) controller 1770 is configured to communicate with the standard functionality 1760 of the ERP system 400 illustrated in FIG. 17B, only via the central data store 1811 within the storage device(s) 1808 of the program server 1800. The negative balance controller 1780 is configured to communicate with the standard functionality 1760 of the ERP system 400 and the BBFC controller 1770 only via the central data store 1811 within the storage device(s) 1808 of the program server 1800. The central data store 1811 is configured such that each of the BBFC controller 1770, the negative balance controller 1780, and the standard functionality 1760 of the ERP system 400 is configured to natively query and update transaction details within the central data store 1811. The updated transaction details are simultaneously available to the BBFC controller 1770, the negative balance controller 1780, and the standard functionality 1760 of the ERP system 400.

In an embodiment, a data store may include data from end user database applications, files or documents, or the random data storage and management property of an organization or an information system. The data store may be structured, unstructured or in another electronic format. Depending on the user organization, the data store may be classified as an application-specific datastore, operational datastore or centralized datastore 1811. A datastore may be designed and implemented by using purpose-built software or through typical database applications. Depending on the complexity and volume of operations, costs and other factors, user organizations may use different data storage systems as available in the market, one of which is Oracle Database, or any other Database. Oracle Database (Relational Database Management System—RDBMS) is a popular one used by many/most of the large and medium sized end-users of ERP Systems 400. Further, an ERP System 400 is a multi-functional, integrated conglomeration of many subsystems and applications. Accordingly, the nomenclature of “central data store” 400 is used in a general, inclusive meaning of a place where data as well as programs, applications, instructions and data including processed information are stored, as well as updated, retrieved or otherwise used (together called storage and management); and in the meaning it is central or common to the whole of the ERP System 400.

As exemplarily illustrated in FIG. 18, the program server 1800 further comprises an input/output (I/O) controller 1803, a network interface 1804, a data bus 1805, a display unit 1806, input devices 1807, a removable drive 1809 for receiving removable media, output devices 1810, or any subset or superset of components thereof. The I/O controller 1803 controls the input and output actions performed, for example, by end users or administrators of the ERP system 400. The network interface 1804 is configured to connect the program server 1800 to the network 1814. In an embodiment, the network interface 1804 is provided as an interface card also referred to as a line card. The network interface 1804 is, for example, one or more of infrared interfaces, interfaces implementing Wi-Fi® of Wi-Fi Alliance Corporation, universal serial bus (USB) interfaces, Ethernet interfaces, frame relay interfaces, cable interfaces, digital subscriber line interfaces, token ring interfaces, peripheral component interconnect (PCI) interfaces, local area network (LAN) interfaces, wide area network (WAN) interfaces, interfaces using serial protocols, interfaces using parallel protocols, asynchronous transfer mode interfaces, fiber distributed data interfaces (FDDI), interfaces based on transmission control protocol (TCP)/internet protocol (IP), interfaces based on wireless communications technology such as satellite technology, radio frequency technology, near field communication, etc.

The data bus 1805 permits communications and exchange of data between the components, for example, 1801, 1802, 1803, 1804, 1806, 1807, 1808, 1809, and 1810 of the program server 1800. The data bus 1805 transfers data to and from the memory unit 1802 and into or out of the processor(s) 1801. The data bus 1805 also facilitates communication between component units of the ERP system 400, for example, the modules 1760, 1770, 1780, 1775, and 1785 of the ERP system 400 illustrated in FIGS. 17A and 17B. The display unit 1806, via a user interface, for example, a graphical user interface (GUI) 1806a, displays user interface elements such as input fields for allowing a user, for example, an operator of the program server 1800 to input data such as transaction codes, etc., into the program server 1800. The display unit 1806 also displays results of functions computed by the ERP system 400 to a user. The GUI 1806a comprises, for example, any one of an online web interface, a web-based downloadable application interface, a mobile-based downloadable application interface, etc. In an embodiment, the GUI 1806a is a user interface, for example, a webpage, rendered by an administrator of an enterprise. The client device(s) 1813 provides access to the user interface, for example, the GUI 1806a, rendered by the program server 1800. In an embodiment, the user interface is accessible by a user through the display unit 1806 and one or more input devices 1807 associated with the program server 1800. The input devices 1807 are used for inputting data into the program server 1800. The client device(s) 1813 is configured to communicate with the program server 1800 through the network interface 1804 associated with the program server 1800. Users and the administrators interact with the program server 1800 using the user interface. The output devices 1810 output the results of the actions computed by the ERP system 400, for example, to the administrators and end users of the ERP system 400. Computer applications and programs are used for operating the program server 1800. The programs are loaded onto the storage device(s) 1808 and into the memory unit 1802 via the removable media drive 1809. In an embodiment, the computer applications and programs are loaded into the memory unit 1802 directly via the network 1814.

The program server 1800 employs an operating system 1812 for performing multiple tasks. The operating system 1812 is responsible for management and coordination of activities and sharing of resources of the program server 1800. The operating system 1812 further manages security of the program server 1800, peripheral devices connected to the program server 1800, and network connections. The operating system 1812 recognizes keyboard inputs and pointing device inputs of an administrator or a user, an output display, files, and directories stored locally on the storage device(s) 1808. The operating system 1812 on the program server 1800 executes different programs, for example, a web browser, an electronic mail (email) application, etc., initiated by the administrators or users of the ERP system 400 using the processor 1801. The operating system 1812 monitors the use of the processor 1801.

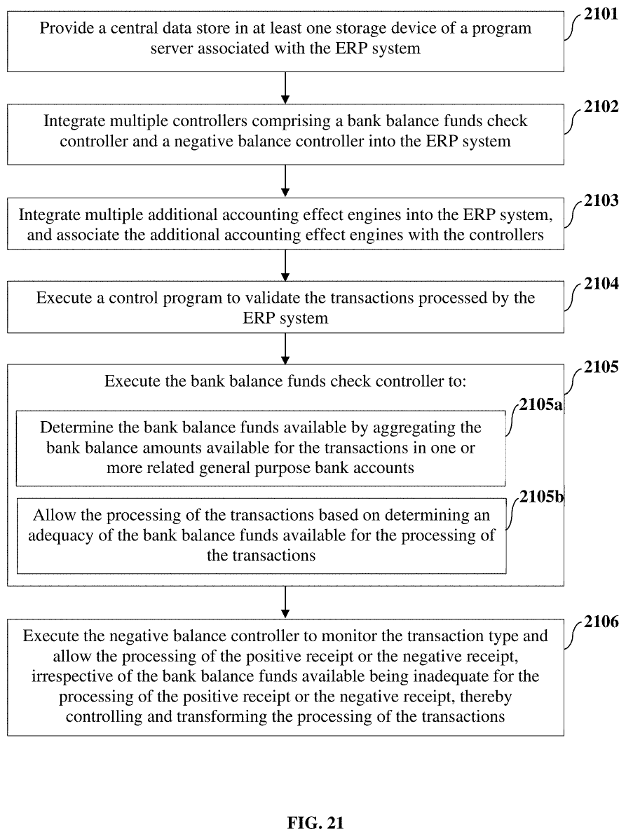

The processor(s) 1801 of the program server 1800 is further configured to execute a control program comprising multiple computer program instructions stored in the storage device(s) 1808 and executable by the processor(s) 1801 of the program server 1800. The computer program instructions when executed by the processor(s) 1801 cause the processor(s) 1801 to validate the transactions processed by the enterprise resource planning (ERP) system 400 as disclosed in the description of FIG. 21. The processor(s) 1801 retrieves the instructions for executing the modules, for example, the bank balance funds check controller 1770, the negative balance controller 1780, the additional accounting effect 1 (AAE1) engine 1775, and the additional accounting effect 2 (AAE2) engine 1785 of the ERP system 400 from the program memory in the form of signals. A program counter determines the location of the instructions in the program memory. The program counter stores a number that identifies the current position in the program of the modules, for example, 1770, 1780, 1775, and 1785 of the ERP system 400.

The instructions fetched by the processor 1801 from the program memory after being processed are decoded. The instructions are placed in an instruction register in the processor 1801. After processing and decoding, the processor 1801 executes the instructions. For example, the bank balance funds check (BBFC) controller 1770 defines instructions for determining the bank balance funds available in one or more bank accounts, on request for conducting a financial transaction, and for validating the financial transaction, if the bank balance funds available (BBFA) is adequate for conducting the financial transaction. In an embodiment, the BBFC controller 1770 also defines instructions for preventing validation of the financial transaction, if the BBFA is inadequate for conducting the financial transaction. In an embodiment, the negative balance controller 1780 defines instructions for validating the financial transaction irrespective of the BBFA being inadequate for processing a receipt, if the financial transaction comprises processing a positive receipt or a negative receipt. In an embodiment, the AAE1 engine 1775 defines instructions for generating an additional accounting effect 1 (AAE1) when an appropriate transaction code is referenced in a user transaction, used in combination with an AAE2 for processing of receipts. In an embodiment, the AAE2 engine 1785 defines instructions for generating the additional accounting effect 2 (AAE2) which is used to allow processing of receipts and manage the situation arising there out of even when the receipts result in a negative bank balance funds deficit (BBFD) or an increase in the existing negative BBFD.

The processor 1801 of the program server 1800 retrieves the instructions defined by the BBFC controller 1770, the negative balance controller 1780, the AAE1 engine 1775, and the AAE2 engine 1785, and executes the instructions. At the time of execution, the instructions stored in the instruction register are examined to determine the operations to be performed. The operations include arithmetic and logic operations. The processor 1801 then performs the specified operation. The operating system 1812 performs multiple routines for performing a number of tasks required to assign the input devices 1807, the output devices 1810, and memory for the execution of the modules, for example, 1770, 1780, 1775, and 1785 of the ERP system 400. The tasks performed by the operating system 1812 comprise assigning memory to the modules, for example, 1770, 1780, 1775, and 1785 of the ERP system 400, moving data between the memory unit 1802 and disk units, handling input/output operations, etc. The operating system 1812 performs the tasks on request by the operations and after performing the tasks, the operating system 1812 transfers the execution control back to the processor 1801. The processor 1801 continues the execution to obtain one or more outputs. The outputs of the execution of the modules, for example, 1770, 1780, 1775, and 1785 of the ERP system 400 are displayed, for example, to the administrator or end users of the ERP system 400.

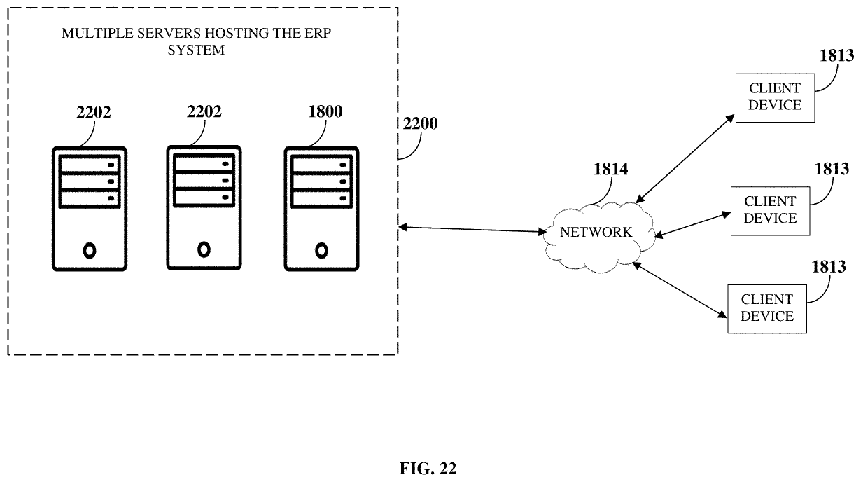

For purposes of illustration, the disclosure herein refers to the modules 1770, 1780, 1775, and 1785 of the ERP system 400 being run locally on a single computer system; however the scope of the computer system and the computer-implemented method disclosed herein is not limited to the modules 1770, 1780, 1775, and 1785 of the ERP system 400 being run locally on a single computer system via the operating system 1812 and the processor(s) 1801, but extends to running the modules 1770, 1780, 1775, and 1785 of the ERP system 400 remotely over the network 1814 by employing a web browser, one or more remote servers, computers, mobile phones, and/or other electronic devices. In an embodiment, one or more modules, databases, processing elements, memory elements, storage elements, etc., of the computer system disclosed herein are distributed across a cluster of computer systems, for example, computers, servers, virtual machines, containers, nodes, etc., as shown in FIG. 22, coupled to the network 1814, where the computer systems coherently communicate and coordinate with each other to share resources, distribute workload, and execute different portions of the logic to control transactions processed by the ERP system 400.

A module, or an engine, or a unit, as used herein, refers to any combination of hardware, software, and/or firmware. As an example, a module, or an engine, or a unit includes hardware such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, C, C++, C#, Java®, Perl®, Python®, etc., for performing one or more steps of the computer-implemented method disclosed herein. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

Disclosed herein also is a computer program product comprising computer executable instructions embodied in a non-transitory, computer-readable storage medium. As used herein, “non-transitory, computer-readable storage medium” refers to all computer-readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The computer program product disclosed herein comprises one or more computer program codes for validating financial transactions performed through an enterprise resource planning (ERP) system 400, by providing controllers 1770 and 1780 and additional accounting effect (AAE) engines 1775 and 1785 to the ERP system 400. In an embodiment, the computer program product disclosed herein comprises a first computer program code for creating a first additional account and a second additional account, where the first additional account and the second additional account is associated with the ERP system 400; a second computer program code for automatically attaching each of the first and second additional accounts with one or more transaction codes for conducting a financial transaction; a third computer program code for providing a bank balance funds check (BBFC) control 0470, 0570 and a negative balance control 0480, 0580 illustrated in FIG. 4, FIG. 5A, and FIG. 5C; a fourth computer program code for integrating the BBFC control 0470, 0570 into the ERP system 400; a fifth computer program code for integrating the negative balance control 0480, 0580 into the ERP system 400; a sixth computer program code for controlling the financial transaction by the BBFC control 0470, 0570 and for controlling the receipts by the negative balance control 0480, 0580; a seventh computer program code for referencing one of the transaction codes and validating the financial transaction by the BBFC control 0470, 0570, if the bank balance funds available is adequate for conducting the financial transaction; and an eighth computer program code for referencing one of the transaction codes and validating the financial transaction by the negative balance control 0480, 0580, if the financial transaction comprises processing a positive receipt or a negative receipt.

The computer program codes comprising the computer executable instructions for validating financial transactions performed through an enterprise resource planning (ERP) system 400 are embodied on the non-transitory, computer-readable storage medium. The processor(s) 1801 of the program server 1800 retrieves these computer executable instructions and executes them. When the computer executable instructions are executed by the processor(s) 1801, the computer executable instructions cause the processor(s) 1801 to perform the method steps for validating financial transactions performed through the ERP system 400, by providing multiple controls to the ERP system 400. In an embodiment, a single piece of computer program code comprising computer executable instructions performs one or more steps of the computer implemented method disclosed herein for validating financial transactions performed through the ERP system 400.

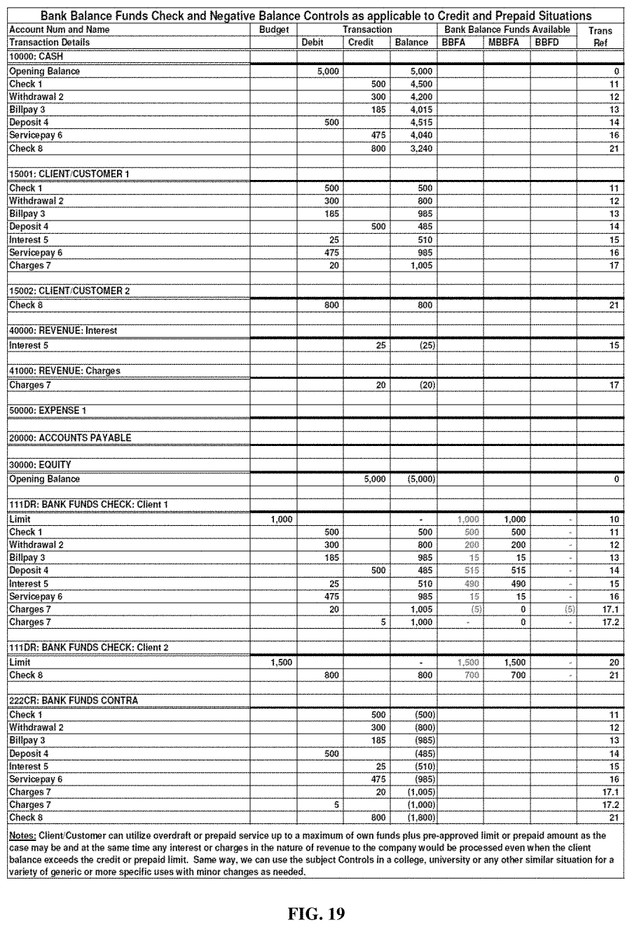

FIG. 19 exemplarily illustrates the implementation and results of the bank balance funds check (BBFC) control 0470, 0570 and the negative balance control 0480, 0580 shown in FIG. 4, FIG. 5A, and FIG. 5C, in credit and prepaid situations, allowing the client/customer to use credit or service, at any time, up to a maximum of own funds plus the limit. In an embodiment of the computer system and the computer-implemented method disclosed herein, the bank balance funds check (BBFC) control 0470, 0570 and the negative balance control 0480, 0580 are used in credit and prepaid situations, where a pre-authorized credit limit or a prepaid amount called a “limit” herein, is set up, by way of entering such limit, instead of $0, as budget for the 111DR account and the additional accounting effect 1 or effects 1 and 2, as hereunto disclosed with reference to FIG. 5A, to allow the client/customer to use the credit or prepaid service up to a maximum of own funds and the limit. Any transaction in the nature of the client/customer using the credit or service beyond the combined total of own funds and the limit fails the validation, and at the same time, any interest or service charges that a service provider may charge, in the nature of revenue to the service provider, is processed even when such transaction results in or increases usage over and beyond the own funds and the limit, as the case may be. The BBFC control 0470, 0570 and the negative balance control 0480, 0580 can also be used in a variety of similar situations, in generic or more specific or applied ways, for similar end-purposes with or without minor changes.

As illustrated in FIG. 19, the amount of the limit is entered as budget for the 111DR account (trans. Ref. 10 for client 1 and trans. Ref. 20 from client 2), instead of $0. In an example, if the “Service pay 6” had been any amount in excess of $490, instead of $475, that transaction would have failed validation (trans. Ref. 16). Furthermore, while “Charges 7” needs both AAE1 and AAE2 (trans. Ref. 17.1 and 17.2), all other transactions shown in FIG. 19 need only AAE1. The charges 7 transaction (Trans. Ref. 17) of $20 is processed even though the existing bank balance funds available of $5 is inadequate for the transaction and results in negative bank balance funds available. Trans. Ref. 17 would have failed validation had the transaction been a transaction of client/customer using credit or service instead of being a service charge charged by the service provider.

FIG. 20A illustrates communication of the bank balance funds check (BBFC) controller 1770 with the standard functionality 1760 of the ERP system 400 only via the central data store 1811 stored within at least one storage device 1808 of the program server 1800 associated with the ERP system 400 shown in FIGS. 17A-18B. The standard functionality 1760 of the ERP system 400 is also referenced as the numeral 460 or 560 as illustrated in FIG. 4 and FIG. 5A. The BBFC controller 1770 is also referenced as the BBFC control 470 or 570 as illustrated in FIG. 4 and FIG. 5A.

FIG. 20B illustrates communication of the negative balance controller 1780 with the standard functionality 1760 of the ERP system 400 and the bank balance funds check controller 1770 only via the central data store 1811 stored within at least one storage device 1808 of the program server 1800 associated with the ERP system 400 shown in FIGS. 17A-18B. The negative balance controller 1780 is also referenced as the negative balance control 480 or 580 as illustrated in FIG. 4 and FIG. 5C.

FIG. 21 illustrates a flowchart of an embodiment of a computer-implemented method for controlling transactions processed by an enterprise resource planning (ERP) system 400 shown in FIG. 4 and FIG. 17B. In an embodiment, the computer-implemented method disclosed herein comprises providing 2101 a central data store 1811 in at least one storage device 1808 of a program server 1800 associated with the ERP system 400 as illustrated in FIGS. 17A-18B and as disclosed in the description of FIG. 18; integrating 2102 multiple controllers, namely, the bank balance funds check (BBFC) controller 1770 and the negative balance controller 1780 into the ERP system 400 as disclosed in the description of FIG. 18; integrating 2103 multiple additional accounting effect (AAE) engines, for example, the AAE1 engine 1775 and the AAE2 engine 1785 into the ERP system 400 as illustrated in FIG. 17B, and associating the AAE engines 1775 and 1785 with the controllers 1770 and 1780; and executing 2104 a control program comprising multiple computer program instructions stored in the storage device(s) 1808 and executable by the processor(s) 1801 of the program server 1800 illustrated in FIG. 18, for validating the transactions processed by the ERP system 400.

The validation of the transactions results in allowing or preventing processing of the transactions by the standard functionality 1760 of the ERP system 400 illustrated in FIG. 17B, thereby improving functioning of the ERP system 400. In an embodiment, the validation of the transactions comprises detecting and handling exceptions that occur during the processing of the transactions by the standard functionality 1760 of the ERP system 400, when the standard functionality 1760 of the ERP system 400 is unable to detect and handle the exceptions. The processing of the transactions comprises processing one of a journal, an invoice, a positive receipt, and a negative receipt. The detection and the handling of the exceptions is based on bank balance funds available and a transaction type. The exceptions comprise one or more of: (a) transactions that result in or increase negative bank balance funds available; and (b) being unable to process the positive receipt or the negative receipt due to an inadequacy of the bank balance funds available for processing the positive receipt or the negative receipt.

The computer-implemented method disclosed herein further comprises executing 2105 the bank balance funds check controller 1770 to determine 2105a the bank balance funds available by aggregating the bank balance amounts available for the transactions in one or more related general purpose bank accounts; and allow 2105b the processing of the transactions based on determining an adequacy of the bank balance funds available for the processing of the transactions, thereby preventing negative bank balance funds from resulting in or increasing in the related general purpose bank account(s) as a result of the processing of the transactions. The computer-implemented method disclosed herein further comprises executing 2106 the negative balance controller 1780 to monitor the transaction type and allow the processing of the positive receipt or the negative receipt, irrespective of the bank balance funds available being inadequate for the processing of the positive receipt or the negative receipt, thereby controlling and transforming the processing of the transactions as disclosed above.

In an embodiment, the computer system disclosed herein controls and transforms the processing of the transactions as follows. The computer system creates a first additional account and a second additional account, each associated with the enterprise resource planning (ERP) system 400. The computer system attaches each of the first additional account and the second additional account with multiple transaction codes associated with the ERP system 400. In an embodiment, the computer system creates the first additional account by initializing a budget for the first additional account to zero; and defining a funds check level to absolute funds check level for the first additional account. The absolute funds check level is configured to check for funds available in the first additional account prior to the processing of the transactions. The transactions are processed only on the determination of the adequacy of the bank balance funds available for the processing of the transactions.

The computer system defines a first additional accounting effect, generated by one of the additional accounting effect (AAE) engines, for example, the AAE1 engine 1775, associated with the bank balance funds check (BBFC) controller 1770, for controlling the processing of the transactions. The computer system defines a second additional accounting effect, generated by another one of the AAE engines, for example, the AAE2 engine 1785, associated with the negative balance controller 1780, for controlling the processing of the positive receipt and the negative receipt. The computer system references one of the transaction codes for controlling the processing of the transactions by the BBFC controller 1770, in communication with the standard functionality 1760 of the enterprise resource planning (ERP) system 400 only via the central data store 1811, based on the determination of the adequacy of the bank balance funds available for the processing of the transactions. The computer system allows the processing of the positive receipt or the negative receipt, by the negative balance controller 1780, in communication with the standard functionality 1760 of the ERP system 400 and the BBFC controller 1770 only via the central data store 1811, irrespective of the bank balance funds available being inadequate for the processing of the positive receipt or the negative receipt.

As part of controlling the processing of the transactions, the bank balance funds check (BBFC) controller 1770, in communication with the standard functionality 1760 of the enterprise resource planning (ERP) system 400 only via the central data store 1811, is configured to prevent the processing of the transactions, on determining the inadequacy or a negative of the bank balance funds available for the processing of the transactions; and the negative balance controller 1780, in communication with the standard functionality 1760 of the ERP system 400 and the BBFC controller 1770 only via the central data store 1811, is configured to provide context-sensitive solutions to handle the exceptions occurring during the processing of the positive receipt or the negative receipt.

The bank balance funds available for the processing of the transactions is an aggregated balance available in the related general purpose bank account(s) for the processing of the transactions, excluding funds prior reserved for other purposes and therefore unavailable for the processing of the transactions. The related general purpose bank account(s) comprises one or more designated accounts for processing payment against the invoice. In an embodiment, the invoice is processed irrespective of availability of sufficient balance in the designated account(s) based on the determined adequacy of the bank balance funds available for the processing of the payment against the invoice.

In the event the controlling of the processing of the transactions leads to an increase or a decrease in the bank balance funds available, and the controlling of the processing of the transactions originates in any sub-ledger other than the accounts payable sub-ledger or the accounts receivable sub-ledger, the first additional accounting effect and the second additional accounting effect are implemented in the any sub-ledger in which the transaction originates in the same way as done in the accounts payable sub-ledger or the accounts receivable sub-ledger. In the event the controlling of the processing of the transactions leads to an increase or a decrease in the bank balance funds available, and none of an accounts payable sub-ledger window, an accounts receivable sub-ledger window, and any other originating sub-ledger window has a provision for the first additional accounting effect and the second additional accounting effect, then the first additional accounting effect and the second additional accounting effect are entered directly in the general ledger and processed concurrently with the processing of the transactions.

In an embodiment, the context-sensitive solutions provided by the negative balance controller 1780 comprise processing of the positive receipt or the negative receipt based on the bank balance funds available being positive; and processing of the positive receipt or the negative receipt based on the bank balance funds available being negative or zero. In an embodiment, the bank balance funds check (BBFC) controller 1770, in communication with the standard functionality 1760 of the enterprise resource planning (ERP) system 400 only via the central data store 1811, is configured to reference a payment transaction code when a distribution account is an expense account and reference a receipt transaction code when the distribution account is a revenue account for controlling the processing of the invoice. In this embodiment, the first additional accounting effect comprises debiting the first additional account and crediting the second additional account by an amount of the invoice.

In an embodiment, the bank balance funds check (BBFC) controller 1770, in communication with the standard functionality 1760 of the enterprise resource planning (ERP) system 400 only via the central data store 1811, is configured to reference a receipt transaction code for controlling the processing of the positive receipt. In this embodiment, the first additional accounting effect comprises crediting the first additional account and debiting the second additional account by an amount of the positive receipt. In another embodiment, the BBFC controller 1770, in communication with the standard functionality 1760 of the ERP system 400 only via the central data store 1811, is configured to reference a receipt transaction code for controlling the processing of the negative receipt. In this embodiment, the first additional accounting effect comprises debiting the first additional account and crediting the second additional account by an amount of the negative receipt.

In an embodiment, for controlling the processing of the negative receipt, the negative balance controller 1780, in communication with the standard functionality 1760 of the enterprise resource planning (ERP) system 400 and the bank balance funds check (BBFC) controller 1770 only via the central data store 1811, is configured to execute the second additional accounting effect comprising crediting the first additional account and debiting the second additional account by an amount equal to a difference between an amount of the negative receipt and an amount of the bank balance funds available based on the bank balance funds available being positive and the amount of the negative receipt being greater than the amount of the bank balance funds available. In another embodiment, for controlling the processing of the negative receipt, the negative balance controller 1780, in communication with the standard functionality 1760 of the ERP system 400 and the BBFC controller 1770 only via the central data store 1811, is configured to execute the second additional accounting effect comprising crediting the first additional account and debiting the second additional account by an amount equal to an amount of the negative receipt based on the bank balance funds available being equal to zero or negative. In another embodiment, for controlling the processing of the positive receipt, the negative balance controller 1780, in communication with the standard functionality 1760 of the ERP system 400 and the BBFC controller 1770 only via the central data store 1811, is configured to execute the second additional accounting effect comprising debiting the first additional account and crediting the second additional account by an amount equal to a least of an amount of the positive receipt and an amount of a bank balance funds deficit. The bank balance funds deficit is negative bank balance funds available, on the bank balance funds available being equal to zero or negative.

In an embodiment, the bank balance funds check (BBFC) controller 1770 is implemented as a standalone control for the processing of the transactions. In another embodiment, the BBFC controller 1770 and the negative balance controller 1780 are implemented for credit and prepaid situations, where a preauthorized limit is entered in addition to the first additional accounting effect and the second additional accounting effect as disclosed in the description of FIG. 19. In this embodiment, the BBFC controller 1770 and the negative balance controller 1780 are configured to allow a customer to use a credit service and/or a prepaid service up to a combined total of the bank balance funds available and the preauthorized limit. Transactions where the customer uses one of funds, the credit service, and the prepaid service beyond the combined total of the bank balance funds available and the preauthorized limit fail. Any interest or charges of a service provider is processed even when the transactions result in or increase usage in the bank balance funds available in the related general purpose bank account(s) over and beyond the bank balance funds available plus the preauthorized limit. In an embodiment, for controlling the processing of the positive receipt, the negative balance controller 1780, in communication with the standard functionality 1760 of the enterprise resource planning (ERP) system 400 and the BBFC controller 1770 only via the central data store 1811, does not generate the second additional accounting effect on determining that the bank balance funds available is positive. In another embodiment, for controlling the processing of the negative receipt, the negative balance controller 1780, in communication with the standard functionality 1760 of the ERP system 400 and the BBFC controller 1770 only via the central data store 1811, does not generate the second additional accounting effect on determining that the bank balance funds available is positive and an amount of the negative receipt is less than or equal to an amount of the bank balance funds available.

In an embodiment, the bank balance funds check (BBFC) controller 1770, in communication with the standard functionality 1760 of the enterprise resource planning (ERP) system 400 only via the central data store 1811, is configured to debit or credit the first additional account, and correspondingly credit or debit the second additional account, by an amount equal to an amount of the transactions. In this embodiment, the negative balance controller 1780, in communication with the standard functionality 1760 of the ERP system 400 and the BBFC controller 1770 only via the central data store 1811, is configured to debit or credit the first additional account, and correspondingly credit or debit the second additional account, by an amount varying based on a combination of the bank balance funds available immediately prior to incoming transactions and details of the incoming transactions, ensuring the debited amount is equal to the credited amount in relation to each of the transactions. In an embodiment, the BBFC controller 1770, the negative balance controller 1780, and the additional accounting effect engines 1775 and 1785, executed on the ERP system 400, are configured to meet requirements of a double entry system of bookkeeping same as the standard functionality 1760 of the ERP system 400.

Disclosed herein is also a non-transitory, computer-readable storage medium configured to store computer program instructions executable by the processor(s) 1801 of the program server 1800 illustrated in FIG. 18, for controlling transactions processed by the ERP system 400 illustrated in FIG. 4, FIG. 5A, and FIG. 17B. The computer program instructions implement the processes of various embodiments disclosed above and perform additional steps that may be required and contemplated for controlling transactions processed by the ERP system 400. When the computer program instructions are executed by the processor(s) 1801, the computer program instructions cause the processor(s) 1801 to perform the steps of the computer-implemented method for controlling transactions processed by the ERP system 400 as disclosed in the detailed description of FIG. 21. In an embodiment, a single piece of computer program code comprising computer program instructions performs one or more steps of the computer-implemented method disclosed in the description of FIG. 21. The processor(s) 1801 retrieves these computer program instructions and executes them.

The focus of the computer system and the computer-implemented method disclosed herein is on an improvement in the functioning of the ERP System by controlling transactions processed by the ERP system 400, and not on tasks for which a generic computer is used in its ordinary capacity. Accordingly, the computer system and the computer-implemented method disclosed herein are not directed to an abstract idea. Rather, the computer system and the computer-implemented method disclosed herein are directed to a specific improvement to the way the ERP system 400 operates with the BBFC controller 1770, the negative balance controller 1780, and the additional accounting effect engines 1775 and 1785, embodied in the method steps disclosed in the description of FIG. 21. The computer system implements one or more specific computer programs to direct transactions processed by an ERP system 400 towards a set of end results. The interactions configured by the computer system allow the BBFC controller 1770 to communicate with the standard functionality 1760 of the ERP system 400 only via the central data store 1811 within at least one storage device 1808 of the program server 1800 illustrated in FIG. 18, and configure the negative balance controller 1780 to communicate with the standard functionality 1760 of the ERP system 400 and with the BBFC controller 1770 only via the central data store 1811 stored within the storage device(s) 1808 of the program server 1800; and from the configuration, through the use of other, separate and autonomous computer programs, validate the transactions processed by the ERP system 400 as disclosed in the description of FIG. 21. To perform the above disclosed method steps, it requires multiple separate computer programs and subprograms, the execution of which cannot be performed by a person using a generic computer with a generic program.

FIG. 22 illustrates a distributed server system 2200, comprising the program server 1800, suitable for hosting the ERP system 400 and implementing the control system 1700. As explained above, the computer system disclosed herein is distributed across a cluster of computer systems, for example, computers, servers 2202, virtual machines, containers, nodes, etc., coupled to the network 1814, where the computer systems coherently communicate and coordinate with each other to share resources, distribute workload, and execute different portions of the logic to control transactions processed by the ERP system 400. The program server 1800 and the servers 2202 are communicatively coupled to the client device(s) 1813 via the network 1814. An ERP System 400 for a very small user organization may comprise both the server, for example, the program server 1800 and client on the same computer. However, in the client-server model, all application components may be housed on a single server, for example, the program server 1800, or there may be multiple servers 2202, 1800, as shown in FIG. 22, with each server housing one or more of different components of the ERP system 400. In case of multiple servers, they may all be housed at the same geographic location or at multiple locations. In an embodiment, dedicated servers may be used for backup purposes.

In an embodiment, data entry directly into the ERP System 400 is done only in smaller user organizations where the volume of transactions and the number of users using the system is limited. But in large organizations, data entry is done directly into the ERP System 400 to a limited extent, but to a large extent, data entry is done on a variety of front-line or point-of-sale systems, and these systems feed (export) the data into the ERP system 400 through interfaces to the ERP system 400. Therefore, these systems are called feeder systems. Feeder systems may be of general kind used by almost all user organizations, or specific to user organizations in a particular vertical or industry as may be mandated by a regulatory framework such as banks, airlines, etc. Apart from the most used keyboard and feeder systems, input devices/tools 1807 may also include mouse, scanner, etc. Another way of inputting data comprises, for example, a service provider offers service using a machine. While the machine offers the service, it is also programmed to automatically generate related softcopy document such as invoice or receipt for the service, prepared depending on the exact nature of the service provided, give a printed copy to the customer, or send it electronically to the customer, and simultaneously feeds the details of the document into the ERP system 400 through an interface. This is an example of a feeder system. The particular way in which data entry is done by a user organization depends on factors such as, exact nature of input data entry, technology options available, costs involved, market trend, volume of transactions and other commercial considerations.

In an embodiment, apart from the output device 1810 such as the display unit 1806 (GUI or otherwise), a printer may be used as an output device 1810, to print various operations relate reports, or system setup and maintenance related reports. Printers may be of general type as used in most offices, or they could be of special-purpose type such as those used for printing tickets, receipts, etc. In earlier years, user organizations would print and distribute/mail hardcopy reports to various internal stakeholders as well as external partners (invoices, receipts, debit/credit memos, and various reports). In the modern age, the ERP System 400 is integrated with a variety of output systems/devices to convert the output to a required format (Word, PDF, Excel, csv, etc.) and send electronically to internal stakeholders as well as external partners using automated emailer systems. In some cases, the ERP System 400 or its output system is interfaced, subject to appropriate security protocols, with the appropriate system of the external partner for this purpose.

Apart from the purpose for which the controls, for example, 0470, 0570, or 1770 and 0480, 0580, or 1780 illustrated in FIG. 4, FIG. 5A, FIG. 5C, and FIG. 17B, have been developed, the controls, for example, 0470, 0570, or 1770 and 0480, 0580, or 1780 can be used in many more ways. Apart from the bank example disclosed above, financial services for example, banks and credit card companies can use the controls, for example, 0470, 0570, or 1770 and 0480, 0580, or 1780 based on similar subject matter principles to prevent clients from borrowing in excess of their limits. A variety of prepaid businesses can use similar controls to prevent using the service beyond the abovementioned limit. Schools, colleges, universities, and a variety of organizations can use similar controls, with minor modifications, as needed, to suit their specific requirements, for a variety of similar objectives. More complex concepts, for example, an overall limit with sub-limits or security variations can also be implemented. While these are some of the uses of the controls, for example, 0470, 0570, or 1770 and 0480, 0580, or 1780, disclosed herein, there could be many other ways of using the controls, for example, 0470, 0570, or 1770 and 0480, 0580, or 1780 in either generic or more specific ways. In brief, the controls, for example, 0470, 0570, or 1770 and 0480, 0580, or 1780 will find use, with or without modifications, in all Oracle® and non-Oracle® enterprise resource planning (ERP) systems, as well as in a variety of other work situations, where needs that are similar or can be considered similar, directly or indirectly, exist or get to exist, in terms of underlying fundamental subject matter concepts, through conscious efforts such as value-added reengineering in ways that can lead to more efficient work processes, in terms of prevention of risks, better compliance, and substantial reduction of costs; in short, a much enhanced utility and overall productivity.

As is normally the case in any software development or implementation, the same objective can usually be achieved in more than one way. It would depend on factors like the requirements and work environment. It will also depend on the approach a particular developer or implementer or inventor uses to visualize, design, and build the required features. The subject controls, for example, 0470, 0570, or 1770 and 0480, 0580, or 1780 have been developed through a combination of financial, accounting, and information systems development principles, to achieve the objectives, based on considerations including process and productivity improvements, workplace efficiencies, prevention of risks, regulatory compliance, and cost effectiveness.

Based on the experience and understanding of the market, the applicant believes that many user organizations can and will benefit from the subject controls, for example, 0470, 0570, or 1770 and 0480, 0580, or 1780, and as such, there is substantial commercial potential. Since the subject of this application is the controls, for example, 0470, 0570, or 1770 and 0480, 0580, or 1780 that enhance the standard functionality 0460, 0560, or 1760 of an underlying ERP system 400 illustrated in FIG. 4, FIG. 5A, and FIG. 17B, the subject high value-added controls, for example, 0470, 0570, or 1770 and 0480, 0580, or 1780 may be integrated as part of standard application suites, following the usual ERP principles of standardization, flexibility, and universal usefulness, in a way they provide enhanced value addition to users across a wide spectrum of sectors, and market as an optional, independent module, targeting medium and large user organizations that need such additional functionality, at an additional cost. Marketing the controls, for example, 0470, 0570, or 1770 and 0480, 0580, or 1780, as a standalone product for the same purpose is another option.

While the underlying fundamental subject matter principles are the same in relation to all ERP systems, how the computer system and the computer-implemented method disclosed herein are developed, how the additional accounting effects are entered or referenced, and how the controls, for example, 0470, 0570, or 1770 and 0480, 0580, or 1780 are ensured could differ in some details based on many factors including how the underlying base system is designed and built and the approach the particular implementer follows. The subject controls, for example, 0470, 0570, or 1770 and 0480, 0580, or 1780 have the potential to reduce the annual recurring costs substantially, apart from preventing the risks of not having them.

The computer system and the computer-implemented method disclosed herein puts together the raw materials, that is, the underlying financial and accounting concepts into the subject bank balance funds check control 0470, 0570, or 1770 and the negative balance control 0480, 0580, or 1780 for ERP systems, creates enhanced value addition to the users, and achieves the intended high value-added objectives. The computer system and the computer-implemented method disclosed herein provide an improved functionality and process that creates enhanced value addition to the user community. The value addition comes from the improved process that puts together the underlying financial and accounting concepts, in a way that would achieve the intended high value-added objectives.

Examples of leading ERP products worldwide into which the subject controls, for example, 0470, 0570, or 1770 and 0480, 0580, or 1780 may be integrated comprise the Oracle® E-Business Suite, PeopleSoft®, JD Edwards®, SAP®, Baan, and Microsoft® Great Plains. Oracle® E-Business Suite, PeopleSoft®, and JD Edwards® are owned by Oracle Corporation headquartered in Austin, Tex., USA; SAP® by SAP AG headquartered at Walldorf, Germany; Baan by Infor Global Solutions headquartered at New York City, N.Y., USA; and Great Plains by Microsoft Corporation headquartered at Redmond, Wash., USA. The Oracle® E-Business Suite is popularly called Oracle® Financials. There are also a host of other ERP products, meeting the needs of different segments of the market.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor, or a similar device. The “non-transitory, computer-readable storage media” also refer to any medium capable of storing or encoding a set of instructions for execution by a computer, a processor, or a similar device and that causes a computer, a processor, or a similar device to perform any one or more of the steps of the method disclosed herein. In an embodiment, the computer programs that implement the methods and algorithms disclosed herein are stored and transmitted using a variety of media, for example, the computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. Various aspects of the embodiments disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the embodiments disclosed herein are implemented as programmed elements, or non-programmed elements, or any suitable combination thereof.

The embodiments disclosed herein are configured to operate in a network environment comprising one or more computers that are in communication with one or more devices via a network. In an embodiment, the computers communicate with the devices directly or indirectly, via a wired medium or a wireless medium such as the Internet, satellite internet, a local area network (LAN), a wide area network (WAN) or the Ethernet, or via any appropriate communications mediums or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers.

The embodiments disclosed herein are not limited to a particular computer system platform, processor, operating system, or network. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network using a communication protocol. The embodiments disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

I claim:

1. A computer system for controlling transactions processed by an enterprise resource planning system, said computer system comprising:
one or more of a custom hardware, a hard-wired logic circuit, a combination of custom hardware and software, and a combination of a hard-wired logic circuit and software;
a program server of said enterprise resource planning (ERP) system, said program server comprising:
at least one processor;
a memory unit operably and communicatively coupled to said at least one processor; and
at least one storage device, said at least one storage device configured to store a central data store therewithin, wherein said central data store is configured for one or more of storage and management of one or more of programs, applications, data, and instructions, and wherein said storage and said management are central to a whole of said ERP system, and wherein communication between component units of said ERP system is facilitated by a data bus;
at least one client device associated with said program server for providing access to a user interface rendered by said program server, wherein said user interface is accessible by a user through a display unit and one or more input devices associated with said program server, and wherein said at least one client device is configured to communicate with said program server through a network interface associated with said program server;
a control system comprising a plurality of controllers integrated into said ERP system, wherein said plurality of controllers comprises:
a bank balance funds check controller configured to communicate with a standard functionality of said ERP system only via said central data store within said at least one storage device of said program server; and
a negative balance controller configured to communicate with said standard functionality of said ERP system and with said bank balance funds check controller only via said central data store within said at least one storage device of said program server, wherein said central data store is configured such that each of said bank balance funds check controller, said negative balance controller, and said standard functionality of said ERP system is configured to natively query and update transaction details within said central data store, and wherein said updated transaction details are simultaneously available to said bank balance funds check controller, said negative balance controller, and said standard functionality of said ERP system; and
a plurality of additional accounting effect engines integrated into said ERP system and associated with said plurality of controllers; and
a control program comprising a plurality of computer program instructions stored in said at least one storage device and executable by said at least one processor of said program server, wherein said computer program instructions when executed by said at least one processor cause said at least one processor to validate one or more transactions processed by said ERP system, wherein said validation of said transactions results in one of allowing and preventing processing of said transactions by said standard functionality of said ERP system, thereby improving functioning of said ERP system, and wherein said validation of said transactions comprises detecting and handling exceptions that occur during said processing of said transactions by said standard functionality of said ERP system, when said standard functionality of said ERP system is unable to detect and handle said exceptions, wherein said processing of said transactions comprises processing one of a journal, an invoice, a positive receipt, and a negative receipt, and wherein said detection and said handling of said exceptions is based on bank balance funds available and a transaction type, wherein said exceptions comprise one or more of: (a) transactions that one of result in and increase negative bank balance funds available; and (b) being unable to process one of said positive receipt and said negative receipt due to an inadequacy of said bank balance funds available for processing one of said positive receipt and said negative receipt;
said bank balance funds check controller configured to:
determine said bank balance funds available by aggregating bank balance amounts available for said transactions in one or more related general purpose bank accounts; and
allow said processing of said transactions based on determining an adequacy of said bank balance funds available for said processing of said transactions, thereby preventing negative bank balance funds from one of resulting in and increasing in said one or more related general purpose bank accounts as a result of said processing of said transactions;
said negative balance controller configured to monitor said transaction type and allow said processing of said one of said positive receipt and said negative receipt, irrespective of said bank balance funds available being inadequate for said processing of said one of said positive receipt and said negative receipt, thereby controlling and transforming said processing of said transactions by said control system, wherein said controlling and said transforming of said processing of said transactions by said control system comprise:
creating a first additional account and a second additional account, each associated with said ERP system;
attaching each of said first additional account and said second additional account with a plurality of transaction codes associated with said ERP system;
defining a first additional accounting effect, generated by one of said additional accounting effect engines associated with said bank balance funds check controller, for said controlling of said processing of said transactions;
defining a second additional accounting effect, generated by another one of said additional accounting effect engines associated with said negative balance controller, for said controlling of said processing of said positive receipt and said negative receipt;
referencing one of said plurality of transaction codes for said controlling of said processing of said transactions by said bank balance funds check controller, in said communication with said standard functionality of said ERP system only via said central data store, based on said determination of said adequacy of said bank balance funds available for said processing of said transactions; and
allowing said processing of said one of said positive receipt and said negative receipt, by said negative balance controller, in said communication with said standard functionality of said ERP system and said bank balance funds check controller only via said central data store, irrespective of said bank balance funds available being inadequate for said processing of said one of said positive receipt and said negative receipt.

2. The computer system of claim 1, wherein as part of said controlling of said processing of said transactions:
said bank balance funds check controller, in said communication with said standard functionality of said ERP system only via said central data store, is configured to prevent said processing of said transactions, on determining one of said inadequacy and a negative of said bank balance funds available for said processing of said transactions; and
said negative balance controller, in said communication with said standard functionality of said ERP system and said bank balance funds check controller only via said central data store, is configured to provide context-sensitive solutions to handle said exceptions occurring during said processing of said one of said positive receipt and said negative receipt.

3. The computer system of claim 2, wherein said bank balance funds available for said processing of said transactions is an aggregated balance available in said one or more related general purpose bank accounts for said processing of said transactions, excluding funds prior reserved for other purposes and therefore unavailable for said processing of said transactions.

4. The computer system of claim 3, wherein said one or more related general purpose bank accounts comprise one or more designated accounts for processing payment against said invoice, and wherein said invoice is processed irrespective of availability of sufficient balance in said one or more designated accounts based on said determined adequacy of said bank balance funds available for said processing of said payment against said invoice.

5. The computer system of claim 4, wherein said processing of said transactions comprises processing said transactions in one or more of an accounts payable sub-ledger, an accounts receivable sub-ledger, and a general ledger.

6. The computer system of claim 5, wherein said processed transactions are posted into said general ledger.

7. The computer system of claim 5, wherein, in the event said controlling of said processing of said transaction leads to one of an increase and a decrease in said bank balance funds available, and said controlling of said processing of said transaction originates in any sub-ledger other than one of said accounts payable sub-ledger and said accounts receivable sub-ledger, said first additional accounting effect and said second additional accounting effect are implemented in said any sub-ledger in which said transaction originates in the same way as done in said one of said accounts payable sub-ledger and said accounts receivable sub-ledger.

8. The computer system of claim 5, wherein, in the event said controlling of said processing of said transaction leads to one of an increase and a decrease in said bank balance funds available, and none of an accounts payable sub-ledger window, an accounts receivable sub-ledger window, and any other originating sub-ledger window has a provision for said first additional accounting effect and said second additional accounting effect, then said first additional accounting effect and said second additional accounting effect are entered directly in said general ledger and processed concurrently with said processing of said transactions.

9. The computer system of claim 2, wherein said context-sensitive solutions comprise:
said processing of said one of said positive receipt and said negative receipt based on said bank balance funds available being positive; and
said processing of said one of said positive receipt and said negative receipt based on said bank balance funds available being one of negative and zero.

10. The computer system of claim 1, wherein said bank balance funds check controller, in said communication with said standard functionality of said ERP system only via said central data store, is configured to reference a payment transaction code when a distribution account is an expense account and reference a receipt transaction code when said distribution account is a revenue account for said controlling of said processing of said invoice, and wherein said first additional accounting effect comprises debiting said first additional account and crediting said second additional account by an amount of said invoice.

11. The computer system of claim 1, wherein said bank balance funds check controller, in said communication with said standard functionality of said ERP system only via said central data store, is configured to reference a receipt transaction code for said controlling of said processing of said positive receipt, and wherein said first additional accounting effect comprises crediting said first additional account and debiting said second additional account by an amount of said positive receipt.

12. The computer system of claim 1, wherein said bank balance funds check controller, in said communication with said standard functionality of said ERP system only via said central data store, is configured to reference a receipt transaction code for said controlling of said processing of said negative receipt, and wherein said first additional accounting effect comprises debiting said first additional account and crediting said second additional account by an amount of said negative receipt.

13. The computer system of claim 9, wherein, for said controlling of said processing of said negative receipt, said negative balance controller, in said communication with said standard functionality of said ERP system and said bank balance funds check controller only via said central data store, is configured to execute said second additional accounting effect comprising crediting said first additional account and debiting said second additional account by an amount equal to a difference between an amount of said negative receipt and an amount of said bank balance funds available based on said bank balance funds available being positive and said amount of said negative receipt being greater than said amount of said bank balance funds available.

14. The computer system of claim 9, wherein, for said controlling of said processing of said negative receipt, said negative balance controller, in said communication with said standard functionality of said ERP system and said bank balance funds check controller only via said central data store, is configured to execute said second additional accounting effect comprising crediting said first additional account and debiting said second additional account by an amount equal to an amount of said negative receipt based on said bank balance funds available being one of equal to zero and negative.

15. The computer system of claim 9, wherein, for said controlling of said processing of said positive receipt, said negative balance controller, in said communication with said standard functionality of said ERP system and said bank balance funds check controller only via said central data store, is configured to execute said second additional accounting effect comprising debiting said first additional account and crediting said second additional account by an amount equal to a least of an amount of said positive receipt and an amount of a bank balance funds deficit, and wherein said bank balance funds deficit is negative bank balance funds available, on said bank balance funds available being one of equal to zero and negative.

16. The computer system of claim 1, wherein said creation of said first additional account comprises:
initializing a budget for said first additional account to zero; and
defining a funds check level to absolute funds check level for said first additional account, wherein said absolute funds check level is configured to check for funds available in said first additional account prior to said processing of said transactions, and wherein said transactions are processed only on said determination of said adequacy of said bank balance funds available for said processing of said transactions.

17. The computer system of claim 1, wherein said bank balance funds check controller is implemented as a standalone control for said processing of said transactions.

18. The computer system of claim 1, wherein said bank balance funds check controller and said negative balance controller are implemented for credit and prepaid situations, comprising:
entering a preauthorized limit instead of a budget of zero on said first additional account, in addition to said first additional accounting effect and said second additional accounting effect, wherein said bank balance funds check controller and said negative balance controller are configured to allow a customer to use one of a credit service and a prepaid service up to a combined total of said bank balance funds available and said preauthorized limit, and wherein transactions where said customer uses one of funds, said credit service, and said prepaid service beyond said combined total of said bank balance funds available and said preauthorized limit fail, and wherein any one of interest and charges of a service provider is processed even when said transactions one of result in and increase usage in said bank balance funds available in said one or more related general purpose bank accounts over and beyond said bank balance funds available plus said preauthorized limit.

19. The computer system of claim 1, wherein, for said controlling of said processing of said positive receipt, said negative balance controller, in said communication with said standard functionality of said ERP system and said bank balance funds check controller only via said central data store, does not generate said second additional accounting effect on determining that said bank balance funds available is positive.

20. The computer system of claim 1, wherein for said controlling of said processing of said negative receipt, said negative balance controller, in said communication with said standard functionality of said ERP system and said bank balance funds check controller only via said central data store, does not generate said second additional accounting effect on determining that said bank balance funds available is positive and an amount of said negative receipt is one of less than and equal to an amount of said bank balance funds available.

21. The computer system of claim 1, wherein said bank balance funds check controller, in said communication with said standard functionality of said ERP system only via said central data store, is configured to one of debit and credit said first additional account, and correspondingly one of credit and debit said second additional account, by an amount equal to an amount of said transactions, and wherein said negative balance controller, in said communication with said standard functionality of said ERP system and said bank balance funds check controller only via said central data store, is configured to one of debit and credit said first additional account, and correspondingly one of credit and debit said second additional account, by an amount varying based on a combination of said bank balance funds available immediately prior to incoming transactions and details of said incoming transactions, ensuring debited amount is equal to credited amount in relation to each of said transactions.

22. The computer system of claim 1, wherein said bank balance funds check controller, said negative balance controller, and said additional accounting effect engines, executed on said ERP system, are configured to meet requirements of a double entry system of bookkeeping same as said standard functionality of said ERP system.

23. A computer-implemented method, comprising:
providing a central data store in at least one storage device of a program server associated with an enterprise resource planning ERP system, wherein said central data store is configured for one or more of storage and management of one or more of programs, applications, data, and instructions, and wherein said storage and said management are central to a whole of said ERP system, and wherein said program server comprises at least one processor and a memory unit operably and communicatively coupled to said at least one processor;
providing a control system comprising a plurality of controllers integrated into said ERP system, wherein said plurality of controllers comprises:
a bank balance funds check controller configured to communicate with a standard functionality of said ERP system only via said central data store within said at least one storage device of said program server; and
a negative balance controller configured to communicate with said standard functionality of said ERP system and with said bank balance funds check controller only via said central data store within said at least one storage device of said program server, wherein said central data store is configured such that each of said bank balance funds check controller, said negative balance controller, and said standard functionality of said ERP system is configured to natively query and update transaction details within said central data store, and wherein said updated transaction details are simultaneously available to said bank balance funds check controller, said negative balance controller, and said standard functionality of said ERP system; and
a plurality of additional accounting effect engines into said ERP system and associating said additional accounting effect engines with said plurality of controllers;
executing a control program comprising a plurality of computer program instructions stored in said at least one storage device and executable by said at least one processor of said program server, wherein said computer program instructions when executed by said at least one processor cause said at least one processor to validate one or more transactions processed by said ERP system, wherein said validation of said transactions results in one of allowing and preventing processing of said transactions by said standard functionality of said ERP system, thereby improving functioning of said ERP system, and wherein said validation of said transactions comprises detecting and handling exceptions that occur during said processing of said transactions by said standard functionality of said ERP system, when said standard functionality of said ERP system is unable to detect and handle said exceptions, wherein said processing of said transactions comprises processing one of a journal, an invoice, a positive receipt, and a negative receipt, and wherein said detection and said handling of said exceptions is based on bank balance funds available and a transaction type, wherein said exceptions comprise one or more of: (a) transactions that one of result in and increase negative bank balance funds available; and (b) being unable to process one of said positive receipt and said negative receipt due to an inadequacy of said bank balance funds available for processing one of said positive receipt and said negative receipt;
executing said bank balance funds check controller to:
determine said bank balance funds available by aggregating said bank balance amounts available for said transactions in one or more related general purpose bank accounts; and
allow said processing of said transactions based on determining an adequacy of said bank balance funds available for said processing of said transactions, thereby preventing negative bank balance funds from one of resulting in and increasing in said one or more related general purpose bank accounts as a result of said processing of said transactions; and
executing said negative balance controller to monitor said transaction type and allow said processing of said one of said positive receipt and said negative receipt, irrespective of said bank balance funds available being inadequate for said processing of said one of said positive receipt and said negative receipt, thereby controlling and transforming said processing of said transactions, wherein said controlling and said transforming of said processing of said transactions comprises:
creating a first additional account and a second additional account, each associated with said ERP system;
attaching each of said first additional account and said second additional account with a plurality of transaction codes associated with said ERP system;
defining a first additional accounting effect, generated by one of said additional accounting effect engines associated with said bank balance funds check controller, for said controlling of said processing of said transactions;
defining a second additional accounting effect, generated by another one of said additional accounting effect engines associated with said negative balance controller, for said controlling of said processing of said positive receipt and said negative receipt;
referencing one of said plurality of transaction codes for said controlling of said processing of said transactions by said bank balance funds check controller, in said communication with said standard functionality of said ERP system only via said central data store, based on said determination of said adequacy of said bank balance funds available for said processing of said transactions; and
allowing said processing of said one of said positive receipt and said negative receipt, by said negative balance controller, in said communication with said standard functionality of said ERP system and said bank balance funds check controller only via said central data store, irrespective of said bank balance funds available being inadequate for said processing of said one of said positive receipt and said negative receipt.

24. A non-transitory, computer-readable storage medium having embodied thereon, computer program instructions executable by at least one processor of a program server of an enterprise resource planning (ERP) system for controlling transactions processed by said ERP system, said computer program instructions when executed by said at least one processor cause said at least one processor to:
configure a bank balance funds check controller of a control system to communicate with a standard functionality of said ERP system only via a central data store within at least one storage device of said program server;
configure a negative balance controller of the control system to communicate with said standard functionality of said ERP system and with said bank balance funds check controller only via said central data store stored within said at least one storage device of said program server, wherein said central data store is configured such that each of said bank balance funds check controller, said negative balance controller, and said standard functionality of said ERP system is configured to natively query and update transaction details within said central data store, and wherein said updated transaction details are simultaneously available to said bank balance funds check controller, said negative balance controller, and said standard functionality of said ERP system;
validate said transactions processed by said ERP system, wherein said validation of said transactions results in one of allowing and preventing processing of said transactions by a standard functionality of said ERP system, thereby improving functioning of said ERP system, and wherein said validation of said transactions comprises detecting and handling exceptions that occur during said processing of said transactions by said standard functionality of said ERP system, when said standard functionality of said ERP system is unable to detect and handle said exceptions, wherein said processing of said transactions comprises processing one of a journal, an invoice, a positive receipt, and a negative receipt, and wherein said detection and said handling of said exceptions is based on bank balance funds available and a transaction type, wherein said exceptions comprise one or more of: (a) transactions that one of result in and increase negative bank balance funds available; and (b) being unable to process one of said positive receipt and said negative receipt due to an inadequacy of said bank balance funds available for processing one of said positive receipt and said negative receipt;
configure said bank balance funds check controller to:
determine said bank balance funds available by aggregating bank balance amounts available for said transactions in one or more related general purpose bank accounts; and
allow said processing of said transactions based on determining an adequacy of said bank balance funds available for said processing of said transactions, thereby preventing negative bank balance funds from one of resulting in and increasing in said one or more related general purpose bank accounts as a result of said processing of said transactions; and
configure said negative balance controller to monitor said transaction type and allow said processing of said one of said positive receipt and said negative receipt, irrespective of said bank balance funds available being inadequate for said processing of said one of said positive receipt and said negative receipt, thereby controlling and transforming said processing of said transactions, wherein said controlling and said transforming of said processing of said transactions comprise:
creating a first additional account and a second additional account, each associated with said ERP system;
attaching each of said first additional account and said second additional account with a plurality of transaction codes associated with said ERP system;
defining a first additional accounting effect, generated by one of a plurality of additional accounting effect engines associated with said bank balance funds check controller, for said controlling of said processing of said transactions;
defining a second additional accounting effect, generated by another one of said plurality of additional accounting effect engines associated with said negative balance controller, for said controlling of said processing of said positive receipt and said negative receipt;
referencing one of said plurality of transaction codes for said controlling of said processing of said transactions by said bank balance funds check controller, in said communication with said standard functionality of said ERP system only via said central data store, based on said determination of said adequacy of said bank balance funds available for said processing of said transactions; and
allowing said processing of said one of said positive receipt and said negative receipt, by said negative balance controller, in said communication with said standard functionality of said ERP system and said bank balance funds check controller only via said central data store, irrespective of said bank balance funds available being inadequate for said processing of said one of said positive receipt and said negative receipt.

25. The non-transitory, computer-readable storage medium of claim 45, wherein the computer program instructions when executed by the at least one processor further cause the at least one processor to:
configure said bank balance funds check controller, in said communication with said standard functionality of said ERP system only via said central data store, to one of debit and credit said first additional account, and correspondingly one of credit and debit said second additional account, by an amount equal to an amount of said transactions; and
configure said negative balance controller, in said communication with said standard functionality of said ERP system and said bank balance funds check controller only via said central data store, to one of debit and credit said first additional account, and correspondingly one of credit and debit said second additional account, by an amount varying based on a combination of said bank balance funds available immediately prior to incoming transactions and details of said incoming transactions, thereby ensuring a debited amount is equal to a credited amount in relation to each of said transactions, wherein said bank balance funds check controller, said negative balance controller, and said additional accounting effect engines, executed on said ERP system, meet requirements of a double entry system of bookkeeping same as said standard functionality of said ERP system.
